(19) United States
(12) Patent Application Publication
(10) Pub. No.: US 2025/0261125 A1
(43) Pub. Date: Aug. 14, 2025

(54) METHOD AND APPARATUS FOR CONTROLLING UPLINK TRANSMISSION OUTPUT DURING MULTI-ANTENNA TRANSMISSION IN WIRELESS COMMUNICATION SYSTEM

(71) Applicant: Samsung Electronics Co., Ltd., Suwon-si (KR)

(72) Inventors: Taekhoon KIM, Suwon-si (KR); Seongmok LIM, Suwon-si (KR); Youngrok JANG, Suwon-si (KR); Hyoungju JI, Suwon-si (KR)

(21) Appl. No.: 19/046,050

(22) Filed: Feb. 5, 2025

(30) Foreign Application Priority Data
Feb. 8, 2024 (KR) 10-2024-0019653

(51) Int. Cl. H04W 52/14; H04W 52/36

(52) U.S. Cl. CPC H04W 52/146; H04W 52/367

(57) ABSTRACT

The disclosure relates to a fifth generation (5G) or sixth generation (6G) communication system for supporting a higher data transmission rate and coverage. A method performed by a user equipment (UE) in a communication system is provided. The method includes transmitting, to a base station, by the UE, UE capability information associated with an output power of a 3^{rd} power amplifier (PA), identifying, by the UE, a maximum UE transmit power P_{CMAX} based on the output power of the 3^{rd} PA and output powers of a 1^{st} PA and a 2^{nd} PA, and transmitting, to the base station, by the UE, an uplink signal based on the identified P_{CMAX}.

### CROSS-REFERENCE TO RELATED APPLICATION(S)

This application is based on and claims priority under 35 U.S.C. § 119 (a) of a Korean patent application number 10-2024-0019653, filed on Feb. 8, 2024, in the Korean Intellectual Property Office, the disclosure of which is incorporated by reference herein in its entirety.

### BACKGROUND

### 1. Field

The disclosure relates to operations of a user equipment (UE) and a base station in a wireless communication system (or mobile communication system). More particularly, the disclosure relates to a method for performing uplink transmission with the maximum available output by using multiple antennas in a wireless communication system, a method for configuring the rated output (configured UE maximum output power) for corresponding operations, a method for configuring the maximum uplink duty cycle in a time division duplex communication band supporting the same, and an apparatus capable of performing the same.

### 2. Description of Related Art

Fifth generation (5G) mobile communication technologies define broad frequency bands such that high transmission rates and new services are possible, and can be implemented not only in “Sub 6 giga hertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced mobile broadband (eMBB), ultra reliable & low latency communications (URLLC), and massive machine-type communications (mMTC), there has been ongoing standardization regarding beamforming and massive multiple input multiple output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for securing coverage in an area in which communication with terrestrial networks is unavailable, and positioning.

Moreover, there has been ongoing standardization in wireless interface architecture/protocol fields regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), or the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for securing coverage in terahertz bands of 6G mobile communication technologies, full dimensional MIMO (FD-MIMO), multi-antenna transmission technologies, such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Development of communication systems has been followed by research regarding an uplink transmission process using three antennas in a specific band, and a method for configuring the output of a UE for supporting the same.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing services in a mobile communication system.

Another aspect of the disclosure is to provide a specific method wherein, based on the fact that, when a user equipment (UE) performs uplink transmission by using multiple antennas in a wireless communication system, the UE cannot perform transmission with the maximum output available based on each antenna's output, the uplink rated output for maximizing the effect of multi-antenna transmission is configured and is reported to the base station, thereby effectively controlling the uplink output.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes transmitting, to a base station, by the UE, UE capability information associated with an output power of a 3^{rd} power amplifier (PA), identifying, by the UE, a maximum UE transmit power P_{CMAX} based on the output power of the 3^{rd} PA and output powers of a 1^{st} PA and a 2^{nd} PA, and transmitting, to a base station, an uplink signal based on the identified P_{CMAX}.

In accordance with an aspect of the disclosure, a method performed by a base station in a communication system is provided. The method includes receiving, from a user equipment (UE), by the base station, UE capability information associated with an output power of a 3^{rd} power amplifier (PA), and receiving, from the UE, by the base station, an uplink signal, wherein the UL signal is transmitted based on a maximum UE transmit power P_{CMAX}, and wherein the P_{CMAX} is based on the output power of the 3^{rd} PA and output powers of a 1^{st} PA and a 2^{nd} PA.

In accordance with an aspect of the disclosure, a user equipment (UE) in a communication system is provided. The UE includes a transceiver and a controller configured to transmit, to a base station, UE capability information associated with an output power of a 3^{rd} power amplifier (PA), identify a maximum UE transmit power P_{CMAX} based on the output power of the 3^{rd} PA and output powers of a 1^{st} PA and a 2^{nd} PA, and transmit, to the base station, an uplink signal based on the identified P_{CMAX}.

In accordance with an aspect of the disclosure, a base station in a communication system, is provided. The base station includes a transceiver and a controller configured to receive, from a user equipment (UE), UE capability information associated with an output power of a 3^{rd} power amplifier (PA), and receive, from the UE, an uplink signal, wherein the UL signal is transmitted based on a maximum UE transmit power P_{CMAX}, and wherein the P_{CMAX} is based on the output power of the 3^{rd} PA and output powers of a 1^{st} PA and a 2^{nd} PA.

Various embodiments of the disclosure provide a device and a method capable of effectively providing services in a mobile communication system. Various embodiments of the disclosure provide a method for securing performance with the optimal output when transmitting an uplink with multiple antennas in a wireless communication system, and an apparatus configured to perform the same.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain, which is a radio resource domain used to transmit data or control channels, in a 5th generation (5G) system according to an embodiment of the disclosure;

FIG. 2 illustrates a structure of a frame, a subframe, and a slot in a 5G communication system according to an embodiment of the disclosure;

FIG. 3 illustrates a bandwidth part configuration in a 5G communication system according to an embodiment of the disclosure;

FIG. 4 illustrates time domain resource allocation with regard to a physical downlink shared channel (PDSCH) in a 5G communication system according to an embodiment of the disclosure;

FIG. 5 illustrates which a user equipment (UE) performs uplink transmission by using three power amplifier (PAs) and antennas according to an embodiment of the disclosure;

FIG. 6 illustrates a process in which a UE configures a P_{CMAX} value by using UE capability indicating total sum power according to an embodiment of the disclosure;

FIG. 7 illustrates a process in which a UE configures a P_{CMAX} value by using UE capability indicating additional power according to an embodiment of the disclosure;

FIG. 8 illustrates a method in which a UE adjusts a maximum rated output value by using maximum uplink duty cycle-related UE capability based on power class 2 according to an embodiment of the disclosure;

FIG. 9 illustrates a method in which a UE adjusts a maximum rated output value by using maximum uplink duty cycle-related UE capability based on power class 2 according to an embodiment of the disclosure;

FIG. 10 illustrates a method in which a UE adjusts a maximum rated output value by using new maximum uplink duty cycle-related UE capability according to an embodiment of the disclosure;

FIG. 11 illustrates a method in which a UE adjusts a maximum rated output value by using new maximum uplink duty cycle-related UE capability according to an embodiment of the disclosure;

FIG. 12 illustrates operations of a UE configured to perform operations according to an embodiment of the disclosure;

FIG. 13 illustrates operations of a base station configured to perform operations according to an embodiment of the disclosure;

FIG. 14 illustrates a structure of a UE in a wireless communication system according to an embodiment of the disclosure; and

FIG. 15 illustrates a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3rd generation partnership project (3GPP), long-term evolution (LTE) or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services, such as the Internet of things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years because it is difficult to frequently replace the battery of the UE.

Lastly, URLLC is a cellular-based mission-critical wireless communication service. For example, URLLC may be used for services, such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 105 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5^{th} generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, the term “a/b” may be understood as at least one of a and b.

### NR Time-Frequency Resources

Hereinafter, a frame structure of a 5G system will be described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

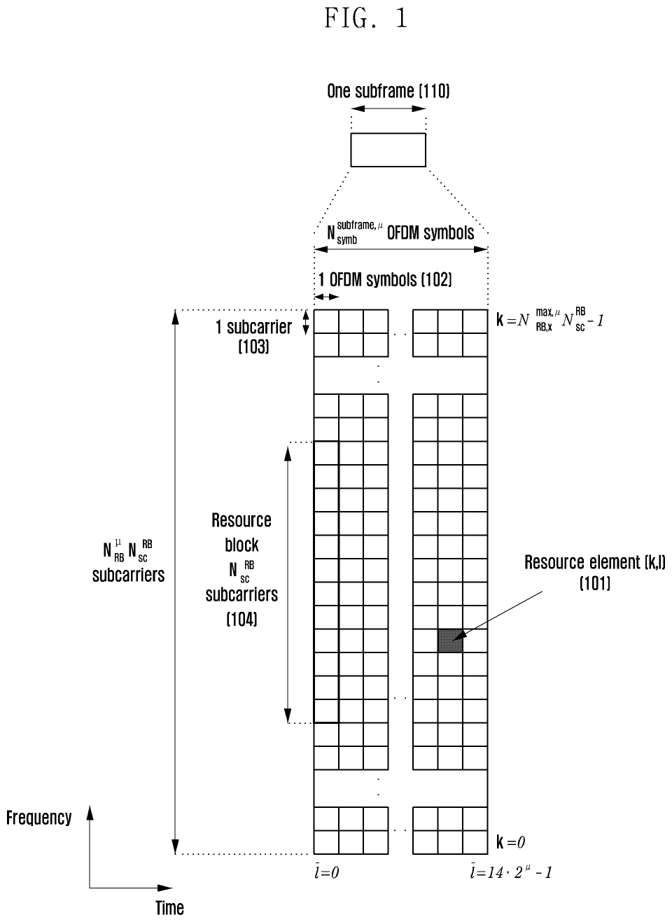

FIG. 1 illustrates a basic structure of a time-frequency domain, which is a radio resource domain used to transmit data or control channels, in a 5G system according to an embodiment of the disclosure.

Referring to FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

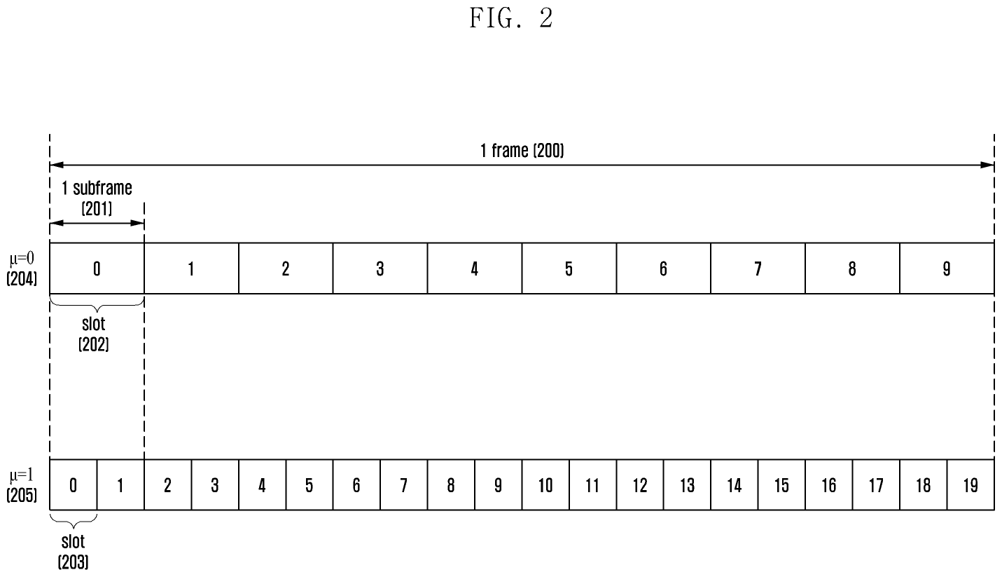

FIG. 2 illustrates a structure of a frame, a subframe, and a slot in a 5G communication system according to an embodiment of the disclosure.

Referring to FIG. 2, an example of a structure of a frame 200, a subframe 201, and a slot 202 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 204, and a case in which μ=1 205. In the case of μ=0 204, one subframe 201 may include one slot 202, and in the case of μ=1 205, one subframe 201 may include two slots 203. For example, the number of slots per one subframe Nₛₗₒₜ^{subframe,μ} may differ depending on the subcarrier spacing configuration value u, and the number of slots per one frame Nₛₗₒₜ^{frame,μ} slot may differ accordingly. Nₛₗₒₜ^{subframe,μ} and Nₛₗₒₜ^{frame,μ} slot may be defined according to each subcarrier spacing configuration u as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, a bandwidth part (BWP) configuration in a 5G communication system will be described with reference to the accompanying drawings.

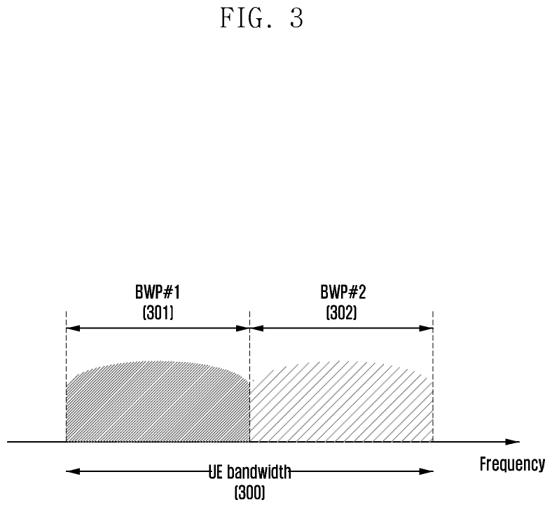

FIG. 3 illustrates a BWP configuration in a 5G communication system according to an embodiment of the disclosure.

FIG. 3 illustrates a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Obviously, the above example is not limiting, and various parameters related to the bandwidth part may be configured for the UE, in addition to the above configuration information. The base station may transfer the configuration information to the UE through higher layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to some embodiments of the disclosure, before a radio resource control (RRC) connection, an initial bandwidth part (BWP) for initial access may be configured for the UE by the base station through a master information block (MIB). More specifically, the UE may receive configuration information regarding a control resource set (CORESET) and a search space, which may be used to transmit a PDCCH for receiving system information (which may correspond to remaining system information (RMSI) or system information block 1 (SIB1)) necessary for initial access, through the MIB on a PBCH in the initial access step. Each of the control resource set and the search space configured through the MIB may be considered identity (ID) 0. The base station may notify the UE of configuration information, such as frequency allocation information, time allocation information, and numerology, regarding CORESET #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0. The initial bandwidth part may be used not only for the purpose of receiving the SIB, but also for other system information (OSI), paging, random access, or the like.

Next, downlink control information (DCI) in a 5G communication system will be described below.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. For example, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information, for example.

TABLE 3

| - | Identifier for DCI formats - [1] bit |
|---|---|
| - | Frequency domain resource assignment -[ log₂(N_{RB}^{UL,BWP}(N_{RB}^{UL,BWP} + |
| 1)/2)] bits | |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH - [2] |
| bits | |
| - | Uplink/ supplementary uplink (UL/SUL) indicator - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information, for example.

```
TABLE 4
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    * For resource allocation type 0, [N_{RB}^{UL,BWP}/P] bits
    * For resource allocation type 1, ┌log₂(N_{RB}^{UL,BWP}(N_{RB}^{UL,BWP} +
    1)/2)┐ bits
  Time domain resource assignment −1, 2, 3, or 4 bits
  Virtual resource block (VRB)-to-physical resource block (PRB)
mapping - 0 or 1 bit, only for resource allocation type 1.
    * 0 bit if only resource allocation type 0 is configured;
    * 1 bit otherwise.
  Frequency hopping flag - 0 or 1 bit, only for resource allocation type
1.
    * 0 bit if only resource allocation type 0 is configured;
    * 1 bit otherwise.
  Modulation and coding scheme - 5 bits
  New data indicator - 1 bit
  Redundancy version - 2 bits
  HARQ process number - 4 bits
  1st downlink assignment index- 1 or 2 bits
    * 1 bit for semi-static HARQ-ACK codebook;
    * 2 bits for dynamic HARQ-ACK codebook with single
    HARQ-ACK codebook.
  2nd downlink assignment index - 0 or 2 bits
    * 2 bits for dynamic HARQ-ACK codebook with two HARQ-
    ACK sub-codebooks;
    * 0 bit otherwise.
  TPC command for scheduled PUSCH - 2 bits
  $SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉$
  bits
    $* ⌈ {log}_{2} ( {\sum }_{k = 1}^{{L}_{max} \sum } ( \begin{matrix}{N}_{SRS} \\ k\end{matrix} ) ) ⌉ bits for non - codebook based$
    PUSCH transmission;
    * ┌log₂(N_{SRS})┐ bits for codebook based PUSCH transmission.
  Precoding information and number of layers - up to 6 bits
  Antenna ports - up to 5 bits
  SRS request - 2 bits
  Channel state information (CSI) request - 0, 1, 2, 3, 4, 5, or 6 bits
  Code block group (CBG) transmission information - 0, 2, 4, 6, or 8
bits
  Phase tracking reference signal (PTRS)-demodulation reference signal
(DDMRS) association - 0 or 2 bits.
  beta_offset indicator - 0 or 2 bits
  DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information, for example.

TABLE 5

```
  - Identifier for DCI formats - [1] bit
  - Frequency domain resource assignment - ┌[log₂(N_{RB}^{DL,BWP}(N_{RB}^{DL,BWP} +
1)/2)]┐ bits
  - Time domain resource assignment - X bits
  - VRB-to-PRB mapping - 1 bit.
  - Modulation and coding scheme - 5 bits
  - New data indicator - 1 bit
  - Redundancy version - 2 bits
  - HARQ process number - 4 bits
  - Downlink assignment index - 2 bits
  - TPC command for scheduled PUCCH - [2] bits
  - Pysical uplink control channel (PUCCH) resource indicator - 3 bits
  - PDSCH-to-HARQ feedback timing indicator - [3] bits
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information, for example.

TABLE 6

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |
| | * For resource allocation type 0, ┌N_{RB}^{DL,BWP}/P┐ bits |
| | * For resource allocation type 1, ┌log₂(N_{RB}^{DL,BWP}(N_{RB}^{DL,BWP} + |
| | 1)/2)┐ bits |
| - | Time domain resource assignment -1, 2, 3, or 4 bits |
| - | VRB-to-PRB mapping - 0 or 1 bit, only for resource allocation type 1. |
| | * 0 bit if only resource allocation type 0 is configured; |
| | * 1 bit otherwise. |
| - | Physical resource block (PRB) bundling size indicator - 0 or 1 bit |
| - | Rate matching indicator - 0, 1, or 2 bits |
| - | Zero power (ZP) channel state information (CSI)-reference signal (RS) |

trigger - 0, 1, or 2 bits
For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

Hereinafter, a time domain resource allocation method regarding a data channel in a 5G system will be described.

A base station may configure a table for time domain resource allocation information regarding a physical downlink shared channel (PDSCH) and a physical uplink shared channel (PUSCH) for a UE through higher layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment of the disclosure, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted, labeled K0), PDCCH-to-PUSCH slot timing (for example, corresponding to a slot-unit time interval between a timepoint at which a PDCCH is received and a timepoint at which a PUSCH scheduled by the received PDCCH is transmitted, hereinafter, labeled K2), information regarding the location and length of the start symbol by which a PDSCH or PUSCH is scheduled inside a slot, the mapping type of a PDSCH or PUSCH, and the like. For example, information, such as in Table 7 or Table 8 below may be transmitted from the base station to the UE.

TABLE 7
PDSCH-TimeDomainResourceAllocationList information element

| PDSCH-TimeDomainResourceAllocationList ::= SEQUENCE | |
|---|---|
| (SIZE(1..maxNrofDL-Allocations)) OF | |
| PDSCH-TimeDomainResourceAllocation | |
| PDSCH-TimeDomainResourceAllocation ::= | SEQUENCE { |
| k0 | INTEGER(0..32) |
| OPTIONAL, -- Need S | |
| (PDCCH-to-PDSCH timing, slot unit) | |
| mappingType | ENUMERATED {typeA, |
| typeB}, | |
| (PDSCH mapping type) | |
| startSymbolAndLength | INTEGER (0..127) |

```
    (start symbol and length of PDSCH)
    }
```

TABLE 8
PUSCH-TimeDomainResourceAllocationList information element

```
  PUSCH-TimeDomainResourceAllocationList ::= SEQUENCE
(SIZE(1..maxNrofUL-Allocations)) OF
  PUSCH-TimeDomainResourceAllocation
```

| | |
|---|---|
| PUSCH-TimeDomainResourceAllocation ::= | SEQUENCE { |
| k2 INTEGER(0..32) | OPTIONAL, -- Need S |

(PDCCH-to-PUSCH timing, slot unit)

| | |
|---|---|
| mappingType | ENUMERATED { typeA, typeB }, |

(PUSCH mapping type)

| | |
|---|---|
| startSymbolAndLength | INTEGER (0..127) |

```
      (start symbol and length of PUSCH)
  }
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

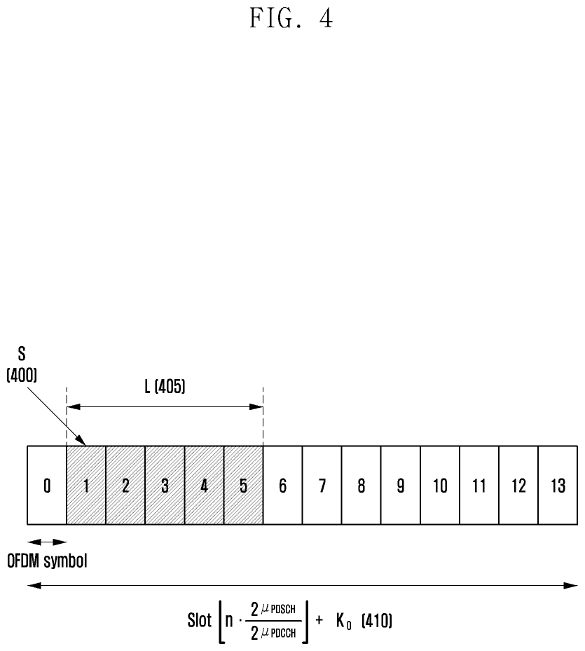

FIG. 4 illustrates a time domain resource allocation with regard to a PDSCH in a 5G communication system according to an embodiment of the disclosure.

Referring to FIG. 4, the UE may indicate the time domain location of a PDSCH resource according to the subcarrier spacing (SCS) (μ_{PDSCH}, μ_{PDCCH}) of a data channel and a control channel configured by using an higher layer, the scheduling offset (K0) value 410, and the OFDM symbol start location 400 and length 405 within one slot dynamically indicated through DCI.

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 9 through higher layer signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 9 through higher layer signaling. If PUSCH transmission is operated by a configured grant, parameters applied to the PUSCH transmission are applied through configuredGrantConfig (higher layer signaling) in Table 9 except for dataScramblingIdentityPUSCH, txConfig, codebookSubset, maxRank, and scaling of UCI-OnPUSCH, which are provided by pusch-Config (higher layer signaling) in Table 10. If provided with transformPrecoder inside configuredGrantConfig (higher layer signaling) in Table 9, the UE applies tp-pi2BPSK inside pusch-Config in Table 10 to PUSCH transmission operated by a configured grant.

TABLE 9

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, |
| qam64LowSE} | OPTIONAL, -- Need S |
| uci-OnPUSCH | SetupRelease { CG-UCI-OnPUSCH } |

OPTIONAL, -- Need M

| | |
|---|---|
| resource Allocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, |
| s3-0000} | OPTIONAL, -- Need R |
| periodicity | ENUMERATED { |
| | sym2, sym7, sym1x14, sym2x14, |

sym4x14, sym5x14, sym8x14, sym10x14, sym16x14, sym20x14,

sym32x14, sym40x14, sym64x14,

sym80x14, sym128x14, sym160x14, sym256x14, sym320x14, sym512x14,

sym640x14, sym1024x14,

sym1280x14, sym2560x14, sym5120x14,

sym6, sym1x12, sym2x12, sym4x12,

sym5x12, sym8x12, sym10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER |

```
(0..maxNrofPUSCH-PathlossReferenceRSs−1),
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 10, which is higher layer signaling, is “codebook” or “nonCodebook”. As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 10, the UE does not expect scheduling through DCI format 0_1.

TABLE 10

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED { codebook, |
| nonCodebook} | OPTIONAL, -- Need S |

dmrs-UplinkForPUSCH-MappingTypeA SetupRelease { DMRS-

| | |
|---|---|
| UplinkConfig } | OPTIONAL, -- Need M |

dmrs-UplinkForPUSCH-MappingTypeB SetupRelease { DMRS-

| | |
|---|---|
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, |
| interSlot} | OPTIONAL, -- Need S |
| frequencyHoppingOffsetLists | SEQUENCE (SIZE (1..4)) OF |
| INTEGER (1..maxNrofPhysicalResourceBlocks−1) | |

OPTIONAL, -- Need M

| | |
|---|---|
| resource Allocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED { qam256, |
| qam64LowSE} | OPTIONAL, -- Need S |
| mcs-TableTransformPrecoder | ENUMERATED { qam256, |
| qam64LowSE} | OPTIONAL, -- Need S |
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED { enabled } |

OPTIONAL, -- Need S
...
}

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers). The SRI may be given through the SRS resource indicator (a field inside DCI) or configured through srs-ResourceIndicator (higher layer signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precoding AndNumberOfLayers (higher layer signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (higher layer signaling). In connection with codebook-based PUSCH transmission, the UE determines a codebook subset, based on codebookSubset inside pusch-Config (higher layer signaling) and TPMI. The codebookSubset inside pusch-Config (higher layer signaling) may be configured to be one of “fully AndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebook Subset (higher layer as signaling) will be configured “fullyAndPartialAndNonCoherent”. In addition, if the UE reported “nonCoherent” as UE capability, UE does not expect that the value of codebookSubset (higher layer signaling) will be configured as “fully AndPartialAndNonCoherent” or “partialAndNonCoherent”. If nrofSRS-Ports inside SRS-ResourceSet (higher layer signaling) indicates two SRS antenna ports, the UE does not expect that the value of codebook Subset (higher layer signaling) will be configured as “partialAndNonCoherent”.

The UE may have one SRS resource set configured therefor, wherein the value of usage inside SRS-ResourceSet (higher layer signaling) is “codebook”, and one SRS resource may be indicated through an SRI inside the corresponding SRS resource set. If multiple SRS resources are configured inside the SRS resource set wherein the value of usage inside SRS-ResourceSet (higher layer signaling) is “codebook”, the UE expects that the value of nrofSRS-Ports inside SRS-Resource (higher layer signaling) is identical for all SRS resources.

The UE transmits, to the base station, one or multiple SRS resources included in the SRS resource set wherein the value of usage is configured as “codebook” according to higher layer signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (higher layer signaling) is “nonCodebook”, non-codebook-based PUSCH transmission may be scheduled for the UE through DCI format 0_1.

With regard to the SRS resource set wherein the value of usage inside SRS-ResourceSet (higher layer signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (higher layer signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (higher layer signaling). With regard to non-codebook-based transmission, the UE does not expect that spatialRelationInfo which is higher layer signaling regarding the SRS resource and associatedCSI-RS inside SRS-ResourceSet (higher layer signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (higher layer signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (higher layer signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

In the following, a method for determining the transmission power of an uplink data channel in a 5G system will be described below.

In a 5G system, the transmission power of an uplink data channel may be determined according to Equation 1 as follows:

$$\text{?} \qquad Equation 1$$

$$\text{?} \text{indicates text missing or illegible when filed}$$

In Equation 1, j refers to a PUSCH's grant type. Specifically, j=0 refers to a PUSCH grant regarding a random access response, j=1 refers to a configured grant, and j∈{2, 3, . . . , J−1} refers to a dynamic grant. P_{CMAX,f,c}(j) refers to the maximum output power configured for the UE regarding carrier f of support cell c with regard to PUSCH transmission occasion i. P_{O_PUSCHb,j,c}(j) is a parameter configured by the sum of P_{O_NOMINAL_PUSCH,f,c}(j) which is configured by a higher layer parameter and P_{O_UE_PUSCHb,f,c}(j) which may be determined through an higher layer configuration and an SRI (in the case of a dynamic grant PUSCH). M_{RB,b,f,c}^{PUSCH}(i) refers to a bandwidth regarding resource allocation expressed in terms of the number of resource blocks with regard to PUSCH transmission occasion i. Δ_{TF,b,f,c}(i) refers to a value determined according to the modulation coding scheme (MCS) and the type of information transmitted through the PUSCH (for example, whether UL-SCH is included or whether CSI is included) or the like. α_{b,f,c}(j) refers to a value for compensating for pathloss, which may be configured through an higher layer configuration and an SRS resource indicator (SRI) (in the case of a dynamic grant PUSCH). PL_{b,f,c} (q_{d}) refers to a downlink link pathloss estimation value estimated by the UE through a reference signal, the reference signal index of which is qu. The reference signal index of q_{d} may be determined by the UE through an higher layer configuration and an SRI (in the case of a dynamic grant PUSCH or a configured grant PUSCH based on ConfiguredGrantConfig including no higher layer configuration rrc-ConfiguredUplinkGrant (type 2 configured grant PUSCH)), or through an higher layer configuration.

f_{b,f,c}(i,l) refers to a closed loop power adjustment value, and may be supported in an accumulation type and an absolute type. If higher layer parameter tpc-Accumulation is not configured for the UE, the closed loop power adjustment value may be adjusted in the accumulation type. f_{b,f,c}(i,l) is determined to be

$$\text{?}$$

$$\text{?} \text{indicates text missing or illegible when filed}$$

which is the sum of a closed loop power adjustment value regarding previous PUSCH transmission occasion i−i₀ and TPC command values regarding closed loop index/received through DCI, between symbol K_{PUSCH}(i−i₀)−1 for transmitting PUSCH transmission occasion i−i₀ and symbol K_{PUSCH}(i) for transmitting PUSCH transmission occasion i. If higher layer parameter tpc-Accumulation is configured for the UE, f_{b,f,c} (i,l) is determined to be δ_{PUSCHb,f,c}(i,l) which is a TPC command value regarding closed loop index/received through DCI. Closed loop index/may be configured to be 0 or 1 if higher layer parameter twoPUSCH-PC-AdjustementStates is configured for the UE, and the value of/may be determined through an higher layer configuration and an SRI (in the case of a dynamic grant PUSCH). The mapping relation between the TPC value δ_{PUSCHb,f,c} and the TPC command field in DCI according to the accumulation type and absolute type may be defined as in Table 11 below:

TABLE 11

| TPC command | Accumulated δ_{PUSCH, b, f, c} | Absolute δ_{PUSCH, b, f, c} |
|---|---|---|
| field | [dB] | [dB] |
| 0 | −1 | −4 |
| 1 | 0 | −1 |
| 2 | 1 | 1 |
| 3 | 3 | 4 |

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange higher layer signaling information as follows, in order to transfer information regarding the SRS resource set.
srs-ResourceSetId: an SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive higher layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through higher layer signaling including RRC signaling or MAC CE signaling, or L1 signaling (for example, DCI). For example, the base station may activate or deactivate periodic SRS transmission for the UE through higher layer signaling. The base station may indicate activation of an SRS resource set having resourceType configured as “periodic” through higher layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through higher layer signaling.

For example, the base station may activate or deactivate semi-persistent SRS transmission for the UE through higher layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through higher layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined based on UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “‘beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 12

| | |
|---|---|
| SRS-Resource ::= | SEQUENCE { |
| srs-ResourceId | , |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, quenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS-PeriodicityAndOffset, |

```
        ...
      },
```

| | |
|---|---|
| periodic | SEQUENCE { |
| periodicityAndOffset-p | SRS-PeriodicityAndOffset, |

```
        ...
      }
  },
```

| | |
|---|---|
| sequenceId | INTEGER (0..1023), |
| spatialRelationInfo | SRS-SpatialRelationInfo |

OPTIONAL, -- Need R
...
}

Configuration information spatialRelationInfo in Table 12 above is applied, with reference to one reference signal, to a beam used for SRS transmission corresponding to beam information of the corresponding reference signal. For example, configuration of the spatialRelationInfo may include the following pieces of information as given in Table 13 below.

TABLE 13

| SRS-SpatialRelationInfo ::= | SEQUENCE { | |
|---|---|---|
| servingCellId | ServCellIndex | OPTIONAL, -- |

Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the above-described spatialRelationInfo configuration, an SS/PBCH block index, CSI-RS index, or SRS index may be configured as the index of a reference signal to be referred to in order to use beam information of a specific reference signal. Higher layer signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If higher layer signaling referenceSignal has a configured value of “ssb-Index”, the UE may apply the reception beam which was used to receive the SS/PBCH block corresponding to ssb-Index as the transmission beam for the corresponding SRS transmission. If higher layer signaling referenceSignal has a configured value of “csi-RS-Index”, the UE may apply the reception beam which was used to receive the CSI-RS corresponding to csi-RS-Index as the transmission beam for the corresponding SRS transmission. If higher layer signaling referenceSignal has a configured value of “‘srs”, the UE may apply the reception beam which was used to transmit the SRS corresponding to srs as the transmission beam for the corresponding SRS transmission. Hereinafter, an SRS for antenna switching will be described.

An SRS transmitted from a UE may be used by a base station to acquire DL channel state information (CSI) (for example, for DL CSI acquisition). As a specific example, in a single-cell or multi-cell (for example, carrier aggregation (CA)) situation based on time division duplex (TDD), the base station (BS) may schedule transmission of an SRS for the user equipment (UE) and may then receive the SRS transmitted from the UE. In this case, the BS may assume reciprocity between the downlink (DL) and uplink (UL) channels, thereby considering that UL channel information estimated based on the SRS transmitted from the UE is DL channel information, and may use this to perform DL signal/channel scheduling for the UE. The BS may indicate, to the UE, that the usage of SRS for DL channel information acquisition is antenna switching.

As an example, according to specifications (for example, 3gpp TS38.214), the usage of an SRS may be configured for the BS and/or UE by using a higher layer parameter (for example, usage of RRC parameter SRS-ResourceSet). The usage of an SRS may be configured to be beam management usage, codebook transmission usage, non-codebook transmission usage, antenna switching usage, or the like.

In case that the BS has configured, for the UE, parameter usage in higher layer signaling SRS-ResourceSet to be “antennaSwitching” as described above, the UE may receive at least one higher layer signaling configuration from the BS according to reported UE capability. The UE may report “supportedSRS-TxPortSwitch” as UE capability, and the value thereof may be as follows. In the following description, “mTnR” may refer to UE capability supporting transmission through m antennas and reception through n antennas.
“tlr2”: a UE capability report value meaning that the UE is capable of a 1T2R operation
“tlr1-tlr2”: a UE capability report value meaning that the UE is capable of a 1T1R or 1T2R operation
“t2r4”: a UE capability report value meaning that the UE is capable of a 2T4R operation
“tlr4”: a UE capability report value meaning that the UE is capable of a 1T4R operation
“tlr6”: a UE capability report value meaning that the UE is capable of a 1T6R operation
“tlr8”: a UE capability report value meaning that the UE is capable of a 1T8R operation
“t2r6”: a UE capability report value meaning that the UE is capable of a 2T6R operation
“t2r8”: a UE capability report value meaning that the UE is capable of a 2T8R operation
“t4r8”: a UE capability report value meaning that the UE is capable of a 4T8R operation
“tlr1-tlr2-tlr4”: a UE capability report value meaning that the UE is capable of a 1T1R, 1T2R, or 1T4R operation
“t1r4-t2r4”: a UE capability report value meaning that the UE is capable of a 1T4R or 2T4R operation
“tlr1-t1r2-t2r2-t2r4”: a UE capability report value meaning that the UE is capable of a 1T1R, 1T2R, 2T2R, or 2T4R operation
“tlr1-t1r2-t2r2-t1r4-t2r4”: a UE capability report value meaning that the UE is capable of a 1T1R, 1T2R, 2T2R, 1T4R, or 2T4R operation
“tlr1”: a UE capability report value meaning that the UE is capable of a 1T1R operation
“t2r2”: a UE capability report value meaning that the UE is capable of a 2T2R operation
“tlr1-t2r2”: a UE capability report value meaning that the UE is capable of a 1T1R or 2T2R operation
“t4r4”: a UE capability report value meaning that the UE is capable of a 4T4R operation
“tlr1-t2r2-t4r4”: a UE capability report value meaning that the UE is capable of a 1T1R, 2T2R, or 4T4R operation

Hereinafter, UE capability reporting will be described.

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. For example, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE configures UE capability according to band information and RAT type requested by the base station. The method in which the UE configures UE capability in an NR system is summarized below:

1. If the UE receives a list regarding LTE and/or NR bands from the base station at a UE capability request, the UE constructs band combinations (BCs) regarding EN-DC and NR standalone (SA). For example, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.

4. The UE selects BCs appropriate for the requested RAT type from the final “candidate BC list” and configures BCs to report. In this step, the UE configures supportedBandCombinationList in a determined order. For example, the UE may configure BCs and UE capability to report according to a preconfigured rat-Type order. (nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

As described above in connection with the method for determining the transmission power of an uplink data channel of a 5G system, the UE may configure the maximum output power regarding carrier f of support cell c. The UE's maximum rated output power configured in this manner is defined to be P_{CMAX,f,c} (configured UE maximum output power), and this is determined by the UE within the boundary of the upper and lower limits as in Equation 2 below:

$${P}_{CMAXL , f , c} \leq {P}_{CMAX , f , c} \leq {P}_{CMAX \_ H , f , c} \qquad Equation 2$$

In Equation 2, the lower limit value P_{CMAX_L,f,c} and the upper limit value P_{CMAX_H,f,c} are determined as in Equation 3 and Equation 4, respectively:

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} \qquad Equation 3$$

$${P}_{CMAX \_ H , f , c} = MIN \{ {P}_{EMAX , c} , {P}_{PowerClass} - Δ {P}_{PowerClass} \} \qquad Equation 4$$

In Equation 3 and Equation 4, P_{EMAX,c} is a p-Max IE which is a BS configuration value defined in TS 38.331, or is a value based on regional regulations, such as the value of additional field additionalPmax in network signaling NR-NS-PmaxList IE.

In Equation 3 and Equation 4, P_{Powerclass} is a UE power class value defined as in the example of Table 12, and no tolerance value is considered in this regard.

TABLE 14

| NR | Class 1 | Tolerance | Class 1.5 | Tolerance | Class 2 | Tolerance | Class 3 | Tolerance |
|---|---|---|---|---|---|---|---|---|
| band | (dBm) | (dB) | (dBm) | (dB) | (dBm) | (dB) | (dBm) | (dB) |
| n1 | | | | | 26 | +2/−3 | 23 | ±2 |
| n2 | | | | | | | 23 | ±2³ |
| n3 | | | | | 26 | +2/−3³ | 23 | ±2³ |
| n5 | | | | | | | 23 | ±2 |
| n7 | | | | | | | 23 | ±2³ |
| n8 | | | | | | | 23 | ±2³ |
| n12 | | | | | | | 23 | ±2³ |
| n13 | | | | | | | 23 | ±2 |
| n14 | 31⁶ | +2/−3 | | | | | 23 | ±2 |
| n18 | | | | | | | 23 | ±2 |
| n20 | | | | | | | 23 | ±2³ |
| n24 | | | | | | | 23 | +2/−3³ |
| n25 | | | | | 26 | +2/−3³ | 23 | ±2³ |
| n26 | | | | | | | 23 | ±2³ |
| n28 | | | | | | | 23 | +2/−2.5 |
| n30 | | | | | | | 23 | ±2 |
| n34 | | | 29⁵ | +2/−3 | 26 | +2/−3 | 23 | ±2 |
| n38 | | | | | | | 23 | ±2 |
| n39 | | | | | 26 | +2/−3 | 23 | ±2 |
| n40 | | | 29⁵ | +2/−3 | 26 | +2/−3 | 23 | ±2 |
| n41 | | | 29⁵ | +2/−3³ | 26 | +2/−3³ | 23 | ±2³ |
| n47 | | | | | | | 23 | ±2 |
| n48 | | | | | | | 23 | +2/−3 |
| n50 | | | | | | | 23 | ±2 |
| n51 | | | | | | | 23 | ±2 |
| n53 | | | | | | | 23 | ±2 |
| n54 | | | | | | | 23 | ±2 |
| n65 | | | | | | | 23 | ±2 |
| n66 | | | | | 26 | +2/−3 | 23 | ±2 |
| n70 | | | | | 26 | +2/−3 | 23 | ±2 |
| n71 | 31⁶ | +2/−3 | | | 26 | +2/−3 | 23 | +2/−2.5 |
| n74 | | | | | | | 23 | ±2 |
| n77 | 31⁶ | +2/−3 | 29⁵ | +2/−3 | 26 | +2/−3 | 23 | +2/−3 |
| n78 | | | 29⁵ | +2/−3 | 26 | +2/−3 | 23 | +2/−3 |
| n79 | | | 29⁵ | +2/−3 | 26 | +2/−3 | 23 | +2/−3 |
| n80 | | | | | 26 | +2/−3³ | 23 | ±2³ |
| n81 | | | | | | | 23 | ±2 |
| n82 | | | | | | | 23 | ±2 |
| n83 | | | | | | | 23 | +2/−2.5 |
| n84 | | | | | 26 | +2/−3 | 23 | ±2 |
| n85 | 31⁶ | +2/−3 | | | | | 23 | ±2³ |
| n86 | | | | | | | 23 | ±2 |
| n89 | | | | | | | 23 | ±2 |
| n91 | | | | | | | 23 | ±2^{3, 4} |
| n92 | | | | | | | 23 | ±2^{3, 4} |
| n93 | | | | | | | 23 | ±2^{3, 4} |
| n94 | | | | | | | 23 | ±2^{3, 4} |
| n95 | | | | | 26 | +2/−3 | 23 | ±2 |
| n97 | | | | | 26 | +2/−3 | 23 | ±2 |
| n98 | | | | | 26 | +2/−3 | 23 | ±2 |
| n99 | | | | | | | 23 | +2/−3³ |
| n100 | 31⁶ | +2/−3 | | | | | 23 | ±2 |
| n101 | 31⁶ | +2/−3 | | | | | 23 | ±2 |
| n104 | | | | | 26 | +2/−3 | 23 | +2/−3 |
| n105 | | | | | | | 23 | +2/−2.5 |

NOTE 1:
P_{PowerClass} is the maximum UE power specified without taking into account the tolerance
NOTE 2:
Power class 3 is default power class unless otherwise stated
NOTE 3:
Refers to the transmission bandwidths confined within F_{UL}_{_{—}}_{low} and F_{UL}_{_{—}}_{low} + 4 MHz or F_{UL}_{_{—}}_{high} − 4 MHz and F_{UL}_{_{—}}_{high}, the maximum output power requirement is relaxed by reducing the lower tolerance limit by 1.5 dB.
NOTE 4:
The maximum output power requirement is relaxed by reducing the lower tolerance limit by 0.3 dB
NOTE 5:
Achieved via dual Tx
NOTE 6:
Generally, PC1 UE is not targeted for smartphone form factor. The UE power class 1 requirements for Band n14 are applicable for public safety scenario only.

If IE powerBoostPi2BPSK is configured to be 1, P_{EMAX,c} is by +3 dB with regard to a power class 3 supporting UE that operates in TDD band n40, n41, n77, n78, and n79 by means of PI/2 BPSK modulation. In case that P_{EMAX,c}>=20 dBm, the UE indicates UE performance powerBoosting-pi2BPSK support during a specific evaluation period, and the ratio of symbols used for UL transmission is 40% or less (the exact evaluation period corresponds to one or more radio frames).

If IE powerBoostPi2BPSK is configured to be 1, ΔP_{PowerClass} is −3 dB with regard to a power class 3 supporting UE that operates in TDD band n40, n41, n77, n78, and n79 by means of PI/2 BPSK modulation. The UE indicates UE performance powerBoosting-pi2BPSK support, and the ratio of symbols used for UL transmission is 40% or less (the exact evaluation period corresponds to one or more radio frames).

In connection with ΔP_{PowerClass}
In the following case, 3 dB may be configured for a UE that support power class 2, or 6 dB may be configured for a UE that support power class 1.5. a) In case that the BS has configured the P-max value to be 23 dBm or lower, or b) in case that the field of UE capability maxUplinkDutyCycle-PC2-FR1 is empty, maxUplinkDutyCycle-PCIdot5-MPE-FR1 is empty, and the ratio of uplink symbols transmitted for a predetermined measurement time is larger than 50%, or c) as defined in TS 38.306 (the exact measurement time is longer than one radio wave frame), the field of UE capability maxUplinkDutyCycle-PC2-FR1 is not empty, and the ratio of uplink symbols transmitted for a predetermined measurement time is larger than maxUplinkDutyCycle-PC2-FR1, or 3) as defined in TS 38.306 (the exact measurement time is longer than one radio wave frame), the field of UE capability maxUplinkDutyCycle-PCIdot5-MPE-FR1 is not empty, and half the ratio of uplink symbols transmitted for a predetermined measurement time is larger than maxUplinkDutyCycle-PCIdot5-MPE-FR1
In the following case, 3 dB may be configured for a UE that support power class 1.5. a) In case that the BS has configured the P-max value to be a value between 23 dBm and 26 dBm, or b) in case that the field of UE capability maxUplinkDutyCycle-PC2-FR1 is empty, maxUplinkDutyCycle-PCIdot5-MPE-FR1 is empty, and the ratio of uplink symbols transmitted for a predetermined measurement time is between 25% and 50%, or c) as defined in TS 38.306 (the exact measurement time is longer than one radio wave frame), the field of UE capability maxUplinkDutyCycle-PC2-FR1 is not empty, and the ratio of uplink symbols transmitted for a predetermined measurement time is between maxUplinkDutyCycle-PC2-FR1 and maxUplinkDutyCycle-PC2-FR1, or d) as defined in TS 38.306 (the exact measurement time is longer than one radio wave frame), the field of UE capability maxUplinkDutyCycle-PCIdot5-MPE-FR1 is not empty, and the ratio of uplink symbols transmitted for a predetermined measurement time is larger than maxUplinkDutyCycle-PCIdot5-MPE-FR1
In the following case, in case that the UE is configured by SUL configurations, and in case that requirements of a basic power class according to UE capability maxUplinkDutyCycle-SULcombination-PC2 are applied in a band indicating UE power class 2, 3 dB is applied.
In case that a UE that supports power class 2 or power class 1.5 additionally indicates SRS-TxSwitch function “tlr2” or “tlr4” or “tlr1-tlr2” or “tlr1-t1r2-t1r4”, 3 dB is applied to SRS transmission regarding which SRS-ResourceSet usage is configured to be “antennaSwitching” with SRS resources configured for respective SRS resource set(s).
In other cases, 0 dB is applied.

ΔT_{IB,c} is an additional tolerance regarding serving cell c, and ΔT_{IB,c} is 0 dB in the absence of corresponding details. In case that the UE simultaneously operates with regard to V2X operating bands, supports multiple band combinations such CA, SUL, or DC, and the operating band belongs to two or more band combinations, the following is applied.
In case that the operating band's frequency range is 1 GHz or less, applicable additional ΔT_{IB,c} needs to be the average value regarding all band combinations defined in this specification, applied to the corresponding operating band among supported band combinations. In case that there is a harmonic relation between a low-band UL and a high-band DL, it is necessary to apply the maximum ΔT_{IB,c} among different supported band combinations, including such bands.
In case that the operating band's frequency range exceeds 1 GHZ, applicable additional ΔT_{IB,c} needs to take the maximum value regarding all band combinations defined in this specification with regard to the corresponding operating band.

ΔT_{C,c} is 1.5 dB when NOTE 3 in Table 14 is applied to serving cell c, and ΔT_{C,c} is otherwise 0 dB.

MPR_{c} is a tolerable maximum power reduction value determined by the modulation scheme and the amount (that is, bandwidth) of uplink transmission resources allocated to the UE with regard to serving cell c. A-MPR_{f,c} is configured according to network signaling (NS) of which the BS informs the UE in order to avoid adjacent band interference avoidance or regional regulations, and is a power reduction value additionally tolerated based on the frequency band in which uplink transmission occurs at carrier f of serving cell c, regional characteristics, the bandwidth of uplink transmission, and the like.

In the case of usage at SRS-ResourceSet configured to be “antennaSwitching” during SRS transmission, ΔT_{RxSRS} is applied as follows:
The UE transmits an SRS through the second SRS resource in the configured SRS resource set every time the SRS-TxSwitch function is displayed as “tlr2” or “tlr1-tlr2”.
The UE transmits an SRS through the second, third, and fourth SRS resources among a total of four SRS resources in all configured SRS resource sets every time the SRS-TxSwitch function is displayed as “11r4”, “tlr4-12r4”, “tlr1-t1r2-tlr4”, or “tlr1-t1r2-t2r2-t1r4-12r4”. Each SRS resource set is configured by one SRS port.
The UE transmits an SRS through the second SRS resource of the second SRS port pair among a total of two SRS port pairs in all configured SRS resource sets every time the SRS-TxSwitch function is displayed as “12r4”, “tlr4-t2r4”, “tlr1-t1r2-12r2-t2r4”, or “tlr1-t1r2-t2r2-t1r4-t2r4”. Each SRS resource set is configured by two SRS ports.
The UE transmits an SRS through DL-only carrier.

In case that the device can support power class 3 or power class 5 or power class 1.5 in the corresponding band, or power class 2 is supported in the corresponding band, and ΔP_{PowerClass}=3 dB, or the UE indicates txDiversity-r16, the ΔT_{RxSRS} value is 4.5 dB with regard to a band the F_{UL_high} of which is higher than the F_{UL_low} of n79, and is 3 dB with regard to a band the F_{UL_high} of which is lower than the F_{UL_low} of n79.

In case that the UE supports power class 2 in the corresponding band, in case that ΔP_{PowerClass}=0 dB, in case that txDiversity-r16 is not indicated, in case that an SRS resource configured for an SRS transmission occasion is configured by one SRS port, the ΔT_{RxSRS} value is 7.5 dB with regard to a band the F_{UL_high} of which is higher than the F_{UL_low} of n79, and is 6 dB with regard to a band the FULL high of which is lower than the F_{UL_low} of n79.

In the case of other SRS transmission, ΔT_{RxSRS} is 0.

P-MPR_{c} refers to power management maximum output power reduction, and the UE may configure the P-MPR_{c} value regarding cell c only in the following cases:
In the case of simultaneous transmission with multiple radio access technologies regarding a scenario outside the 3GPP range, in order to observing applicable electromagnetic power density exposure requirements which are human influence evaluation standards limited by regulations, or for addressing requirements, such as unnecessary radiation, magnetic interference, and the like.
In case that the output is temporarily reduced through a proximity detection sensor mounted on the UE, in order to observing applicable electromagnetic power density exposure requirements which are human influence evaluation standards limited by regulations.

For reference, P-MPRc has been introduced in the P_{CMAX,f,c} equation such that the UE can report available maximum output transmission power to the BS, and this information may be used by the BS to determine scheduling.

For reference, P-MPRc may affect the maximum uplink performance regarding the selected uplink transmission path.

T_{REF} and Tₑᵥₐₗ (evaluation time) are specified in Table 12. With regard to each T_{REF}, P_{CMAX,L,c} regarding serving cell c is evaluated for each Tₑᵥₐₗ, and is given as a cancelation value taken with regard to transmission in the Tₑᵥₐₗ. Thereafter, minimum P_{CMAX_L,f,c} regarding at least one Tₑᵥₐₗ is applied to the entire T_{REF}.

TABLE 15

| T_{REF} | Tₑᵥₐₗ | Tₑᵥₐₗ with frequency hopping |
|---|---|---|
| Physical channel | Physical channel | Min(Tₙₒ_{_{—}}_{hopping}, Physical Channel |
| length | length | Length) |

Measured configured maximum output power P_{UMAX,f,c} needs to be within the following range:

$${P}_{CMAX \_ L , f , c} - MAX \{ {T}_{L , c} , T ( {P}_{CMAX \_ L , f , c} ) \} \leq {P}_{UMAX , f , c} \leq {P}_{CMAX \_ H , f , c} + T ( {P}_{CMAX \_ H , f , c} ) . \qquad Equation 5$$

wherein the tolerance T (P_{CMAX,f,c}) regarding the applicable value of P_{CMAX,f,c} is specified in Table 12. Tolerance T_{L,c} is the absolute value of the lower-limit tolerance of the designated corresponding operating band.

TABLE 16

| P_{CMAX, f, c} (dBm) | Tolerance T(P_{CMAX, f, c}) (dB) |
|---|---|
| 23 ≤ P_{CMAX, c} ≤ 33 | 2.0 |
| 21 ≤ P_{CMAX, c} ≤ 23 | 2.0 |
| 20 ≤ P_{CMAX, c} < 21 | 2.5 |
| 19 ≤ P_{CMAX, c} < 20 | 3.5 |
| 18 ≤ P_{CMAX, c} < 19 | 4.0 |
| 13 ≤ P_{CMAX, c} < 18 | 5.0 |
| 8 ≤ P_{CMAX, c} < 13 | 6.0 |
| −40 ≤ P_{CMAX, c} < 8 | 7.0 |

### First Embodiment: UE Structure-Specific Available Output During Uplink Multi-Antenna Transmission

Hereinafter, various scenarios that may be considered when a UE transmits an uplink channel by using three power amplifiers and antennas in a specific frequency band will be enumerated, scenarios in which the UE is capable of the maximum uplink output with a legacy UE power class and other scenarios will be distinguished based thereon, and methods for improving impossible scenarios will be described below.

The transmission power which a UE that supports FR1 may have during uplink transmission in a specific frequency band is managed as the UE's output class, and power classes are defined, with reference to a handheld UE (for example, smartphone), as follows: power class 3 (23 dBm), power class 2 (26 dBm), and power class 1.5 (29 dBm). The transmission power of a UE supporting power class 2 and power class 3 is assumed basically with reference to the output from one power amplifier (PA). In contrast, power class 1.5 (in some cases, power class 2 is also included) is solely defined with reference to the sum of outputs generated by a total of two antennas, two PAs for power class 2 (26 dBm) being connected to each antenna. In addition, power class 1 (31 dBm) which supports a higher output than the same is limited to UEs that support public safety networks used in connection with vehicles or ships handled by professionals engaged in special jobs or tasks, not handheld UEs, and is defined to be operable in bands that support such public safety networks.

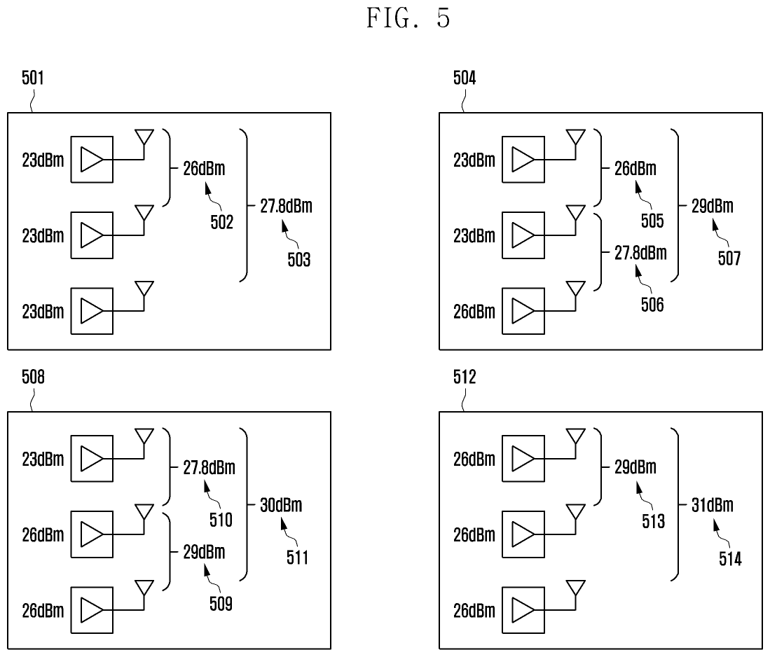

In case that the UE has conducted uplink transmission by using three PAs and antennas, based on a non-coherent UL codebook, in a specific frequency band, the total power level at which the UE may conduct transmission may be considered in three examples according to the PA and antenna structures as in FIG. 5.

FIG. 5 illustrates a UE according to an embodiment of the disclosure performs uplink transmission by using three PAs and antennas according to an embodiment of the disclosure.

Referring to FIG. 5, —[Example 1-1] in case that three PAs and antennas support power class 3 (23 dBm) 501: it is assumed that three identical PAs supporting power class 3 (23 dBm) can simultaneously support a specific frequency band. Assuming a non-coherent UL codebook, and according to the number of actually transmitting antenna ports, uplink power may be 23 dBm (200 mw), which is one PA's power, during one-port transmission, and uplink power may be 26 dBm (400 mW) 502, which is twice 23 dBm (200 mw), during two-port transmission 902. Lastly, assuming that 3-port antennas are all used, the UE can transmit an uplink signal with 27.8 dBm (600 mw) 503, which is three times 23 dBm 903.

Referring to FIG. 5, it is possible to support already defined power classes 3 and 2 during one-port or two-port transmission, but there is no class supported during three-port transmission. Therefore, the corresponding UE needs to transmit an uplink signal by forcibly lowering the uplink power to power class 2 during three-port transmission.
[Example 1-2] in case that two PAs and antennas support power class 3 (23 dBm), and one PA and antenna support power class 2 (26 dBm) 504: it may be assumed, as another example in which three PAs and antennas are used for uplink transmission in a specific band, that one PA supporting power class 2 (26 dBm, 400 mW) is connected to one antenna port, and each of two identical PAs supporting power class 3 (23 dBm, 200 mW) is connected to one antenna port. In this case, assuming a non-coherent UL codebook, and according to the number of actually transmitting antenna ports, uplink power may be 23 dBm (200 mW) or 26 dBm (400 mW), which is one PA's power, during one-port transmission, and may be 26 dBm (400 mW) 505, which is twice 23 dBm (200 mW), or 27.8 dBm (600 mW) 506, which is a combination of 23 dBm and 26 dBm during two-port transmission. Lastly, assuming that 3-port antennas are all used, the UE can transmit an uplink signal with 29 dBm (800 mw) 507.

The scenario of this example has a similar problem in that, during two-port transmission, even if the UE is capable of uplink output at 27.8 dBm (600 mW), there is no power class supporting the same, and the UE thus needs to transmit an uplink signal by forcibly lowering the uplink power to power class 2, and it is necessary to define a new requirement for performing transmission with three ports at power class 1.5 during three-port transmission (for example, legacy power class 1.5 has defined each corresponding power class requirement by assuming two-port transmission).
[Example 1-3] in case that one PA and antenna support power class 3 (23 dBm), and two PAs and antennas support power class 2 (26 dBm) 508: it may be assumed, as another example, that each of two PAs supporting power class 2 (26 dBm, 400 mW) is connected to one antenna port, and one PA supporting power class 3 (23 dBm, 200 mW) is additionally connected to one antenna port. In this case, assuming a non-coherent UL codebook, and according to the number of actually transmitting antenna ports, uplink power may be 23 dBm (200 mW) or 26 dBm (400 mW), which is one PA's power, during one-port transmission, and may be 29 dBm (800 mW) 509, which is twice 26 dBm (400 mW), or 27.8 dBm (600 mW) 506, which is a combination of 23 dBm and 26 dBm during two-port transmission 510. Lastly, assuming that 3-port antennas are all used, the UE can transmit an uplink signal with 30 dBm (1000 mw) 511.

The scenario of this example has a similar problem in that, during two-port transmission, even if the UE is capable of uplink output at 27.8 dBm (600 mW), the UE needs to transmit an uplink signal forcibly with power class 2, and even if 30 dBm (1000 dBm) uplink output is possible, the UE needs to transmit an uplink signal by reusing power class 1.5 during three-port transmission.
[Example 1-4] in case that three PAs and antennas support power class 2 (26 dBm) 512: it may be lastly assumed that each of three PAs supporting power class 2 (26 dBm) is connected to one antenna port. In this case, assuming a non-coherent UL codebook, and according to the number of actually transmitting antenna ports, uplink power may be 26 dBm (400 mW), which is one PA's power, during one-port transmission, and may be 29 dBm (800 mW), which is twice 26 dBm (400 mW), during two-port transmission 513. Lastly, assuming that 3-port antennas are all used, the UE can transmit an uplink signal with 31 dBm (1200 mw) 514, but it is necessary to define a new requirement for performing transmission with three ports of a handheld UE at power class 1 (for example, legacy power class 1 has defined requirements limited to dedicated UEs supporting public safety networks).

To summarize, regarding the output level at which a UE can perform uplink transmission by using three PAs and antenna ports in one specific frequency band, there may be a total of six cases including 23 dBm, 26 dBm, 27.8 dBm, 29 dBm, 30 dBm, and 31 dBm according to the UE's structure and the number of transmitting antenna ports, as described in the previous example.

However, the upper limit of uplink maximum rated output (hereinafter, referred to as P_{CMAX}) that the UE may configure and report to the BS is determined by Equation 4, and it may be thus considered that the actually transmitted UE output level depends on the UE power class. In this case, in the case of 27.8 dBm (600 mW) or 30 dBm (1000 mW) which is not included in power classes that the UE may report, the UE needs to perform transmission by forcibly lowering the uplink output to the level of output class below the same. For example, in case that the output is 27.8 dBm, the output is down-adjusted to power class 3 (23 dBm) or power class 2 (26 dBm). In case that the output is 30 dBm, transmission may be performed by lowering the output to power class 1.5 (29 dBm), power class 2 (26 dBm), or power class 3 (23 dBm).

Even if the UE can use a total of three PAs and antenna ports, there is no difference from legacy transmission performed by using two PAs and antennas, from the viewpoint of uplink output. Therefore, even if the UE has additional PAs and antennas, sufficient performance improvement cannot be expected in proportion thereto.

### Second Embodiment: Method for Defining Maximum Output Based on Total Output Available During Uplink Multi-Antenna Transmission

Hereinafter, methods wherein, when a UE transmits an uplink by using three PAs and antennas in a specific band, the maximum rated output (hereinafter, referred to as P_{CMAX}) of the UE that supports corresponding functions is defined with reference to the total output actually available to the UE, will be described below.

As described above, in the case of legacy P_{CMAX}, the upper and lower limits of P_{CMAX} are derived with reference to P_{PowerClass} and ΔP_{PowerClass}, which are indicators based on a band-specific power class available to the UE, as in Equation 3 and Equation 4, and P_{PowerClass} among the same follows a predefined UE power class. Therefore, in case that, even if the UE performs uplink transmission by using multiple PAs and antennas, each PA has a different output level, for example, in case that a PA supporting 23 dBm and a PA supporting 26 dBm are used to support uplink transmission, the sum of output levels of signals transmitted by the two antennas is different from the power class value, and P_{PowerClass} is thus configured to be a power class of a lower output, there is a problem in that the UE may fail to sufficiently reflect the total output level of transmission using multiple PAs and antennas in P_{CMAX}. For example, even if PAs and antennas are added to support uplink output, performance improvement cannot be expected in proportion.

As a method for addressing such issues, the UE may introduce a new UE capability such that, in case that the UE supports a specific band by using three PAs and antennas, the legacy power class-based indicator P_{PowerClass} is replaced with the total output value that the UE can actually support with multiple antennas when deriving P_{CMAX}.

In this regard, P_{PowerClass} may be configured in the following method. As an example, in case that the UE performs uplink transmission by using three antennas, based on a structure that the UE may implement, and in case that the UE reports a new UE capability (for example, [higherPowerLimit-3Tx]) supporting this, P_{PowerClass} is newly configured with reference to the total output value that can be transmitted with three antennas. Alternatively, a PA level (or power class) added to be supported with three antennas, from the legacy power class supported with two antennas, may be indicated such that the linear sum possible with three antennas is derived, thereby newly configuring indicator P_{PowerClass}. For example, in order to determine the maximum P_{CMAX} that may be transmitted by the UE, the UE and BS may consider using a combination of at least one of various methods described below, based on the legacy P_{PowerClass} value corresponding to transmission using two PAs and antennas, thereby replacing the same with a P_{PowerClass} value corresponding to transmission using three PAs and antennas.

### [Method 2-1] Antenna Output (Power Class) Sum-Based Method

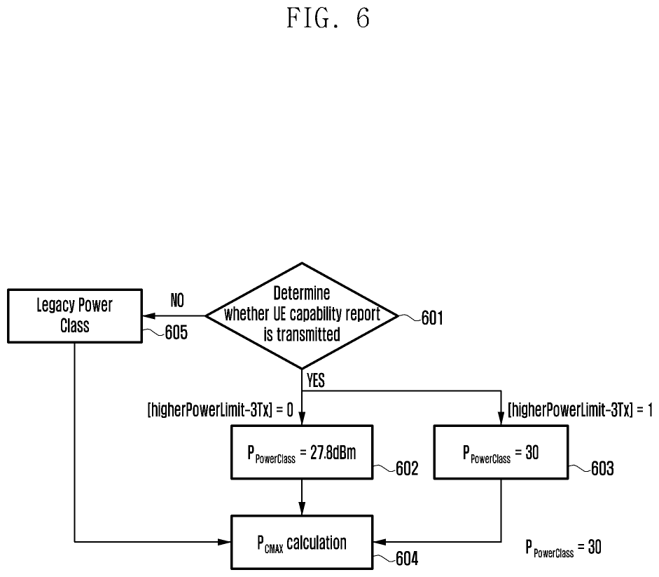

FIG. 6 illustrates a process in which a UE configures a P_{CMAX} value by using UE capability indicating total sum power according to an embodiment of the disclosure.

Referring to FIG. 6, the UE may report, to the BS, a P_{CMAX} value configured based on the actual sum power by using UE capability (for example, [higherPowerLimit-3Tx]) indicating total sum power different from the legacy power class when the UE transmits an uplink signal by using three PAs and antennas. If the UE capability is reported, the UE may derive P_{CMAX} by replacing P_{PowerClass} based on the legacy band-specific UE class with new P_{PowerClass}.

For example, it is determined whether the UE reports new UE capability (for example, [higherPowerLimit-3Tx]) in operation 601. When reporting, the UE may configure and report 27.8 dBm or 30 dBm, which is new sum power in addition to the legacy power class, to be 0 or 1, respectively, for example. Therefore, in case that this is configured to be 0 (in the case of 27.8 dBm), the new P_{PowerClass} that may be applied when transmitting an uplink signal with three antennas may be configured to be 27.8 dBm in operation 602. On the other hand, this is configured to be 1, the new P_{PowerClass} that may be applied when transmitting an uplink signal with three antennas may be configured to be 30 dBm in operation 603. The UE may calculate the P_{CMAX} value according to the reported P_{PowerClass} in operation 604 and may transmit an uplink signal.

The BS may be aware, based on UE capability reporting, of the PA on which the UE performs transmission by using three antennas, and the maximum output of each PA. For example, in case that the output when the UE uses three antennas in a specific band is different from the legacy power class, and in case that the UE report to the BS that corresponding UE capability is 0 or 1, the BS may be aware that the UE uses three antennas, P_{PowerClass} is configured such that the total power available is 27.8 dBm or 30 dBm, and the UE calculates the P_{CMAX} value and transmits an uplink signal.

In this manner, even if the total sum of three antenna outputs is not a value included in legacy power classes, the same is available when deriving P_{CMAX}, the P_{PowerClass} value is not configured based on a low power class (for example, the sum output is adjusted to 26 dBm with reference to 27.8 dBm or power class 2), and P_{PowerClass} and P_{CMAX} may be configured with reference to the actual sum output. Therefore, artificial P_{CMAX} value adjustment due to restrictions by specifications may be avoided, and from the viewpoint of the UE's uplink output, improved performance (for example, uplink coverage) may be expected from transmission with three antennas compared with legacy two antenna-based transmission. For example, in case that the UE is capable of an output using three antennas in a specific band, and in case that the UE reports corresponding UE capability to the BS, the BS may be aware that the UE uses three antennas, and may transmit a P_{CMAX} value based on the sum power thereof.

In case that the UE has performed no UE capability reporting in operation 601, or in case that the UE capability report includes information indicating that a legacy power class will be followed, the UE may follow the legacy lower class in operation 605. The UE may calculate P_{CMAX} by configuring P_{PowerClass} according to the legacy power class in operation 604, and may transmit an uplink signal by using the calculated P_{CMAX}. The BS may also be aware that the UE calculates P_{CMAX} by configuring P_{PowerClass} according to the legacy power class and then transmits an uplink signal.

Above-described values are only examples, and applying other values is also sufficiently possible. The above-described flowchart illustrates a method that may be implemented according to the disclosure's principle, and the method illustrated in the flowchart in the specification may be variously modified. For example, although illustrated as a series of steps, various steps in respective drawings may overlap, occur in parallel, occur in a different order, or occur multiple times. In another example, steps may be omitted or replaced with other steps.

### [Method 2-2] Added Output Value-Based Method

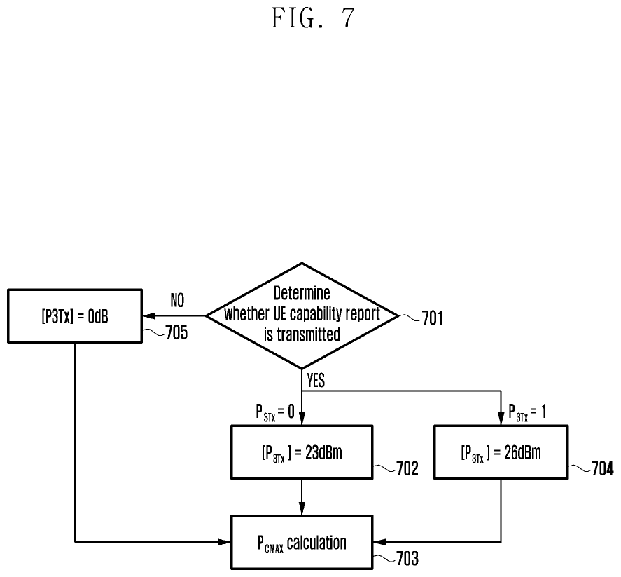

FIG. 7 illustrates a process in which a UE configures a P_{CMAX} value by using UE capability indicating additional power according to an embodiment of the disclosure.

Referring to FIG. 7, in another method, in case that the UE supports three antennas and reports UE capability (for example, [higherPowerLimit-3Tx]) indicating total sum power different from the legacy power, the UE and BS may configure an added output value based on the bit value of corresponding UE capability and may summate the same and the legacy power class, thereby having new P_{PowerClass} and P_{CMAX} values configured or reported.

For example, in a legacy band in which uplink transmission is possible with power class 2, the UE may determine whether or not to report new UE capability supporting three antennas in operation 701. In case that the UE reports new UE capability, one PA and uplink transmission antenna added in the corresponding band may the output value of 23 dBm or 26 dBm, and the UE may thus configure and report the same to be 0 or 1, respectively, for example, as UE capability. Therefore, in case that the UE configured the added PA's output value to be 0 (in the case of 23 dBm), the new parameter (for example, P_{3Tx}]) value that may be applied during three-antenna transmission is 23 dBm in operation 702, and the UE may derive P_{CMAX} based on a linear sum of legacy P_{PowerClass} and [P_{3Tx}] in operation 703. The BS may be already be aware of the output value of two different PAs. For example, the UE may determine P_{CMAX} based on the linear sum of the output value of two different PAs and the output value of the added PA.

On the other hand, in case that the UE configured the added PA's output value to be 1, the new parameter (for example, P_{3Tx}]) value that may be applied during three-antenna transmission is 26 dBm in operation 704, and the UE may derive P_{CMAX} based on a linear sum of legacy P_{PowerClass} and [P_{3Tx}] in operation 703. For example, the UE may determine P_{CMAX} based on a linear sum of the output value of two different PAs and the output value of the added PA. For example, in case that the UE is capable of an output using three antennas in a specific band, and in case that the UE reports 0 or 1 as corresponding UE capability to the BS, the BS may be aware that the UE uses three antennas, configures a P_{CMAX} value based on power corresponding to the sum of the legacy power class and 23 dBm or 26 dBm, and transmits an uplink signal.

In case that the UE has performed no UE capability reporting in operation 701, or in case that the 0 dBm has been reported as [P_{3Tx}], the UE may follow the legacy lower class based on the output of two different PAs in operation 705. The UE may calculate P_{CMAX} by configuring P_{PowerClass} according to the legacy power class in operation 703, and may transmit an uplink signal by using the calculated P_{CMAX}. The BS may also be aware that the UE calculates P_{CMAX} by configuring P_{PowerClass} according to the legacy power class and then transmits an uplink signal.

Above-described values are only examples, and applying other values is also sufficiently possible. The above-described flowchart illustrates a method that may be implemented according to the disclosure's principle, and the method illustrated in the flowchart in the specification may be variously modified. For example, although illustrated as a series of steps, various steps in respective drawings may overlap, occur in parallel, occur in a different order, or occur multiple times. In another example, steps may be omitted or replaced with other steps.

### [Method 2-3] Method for Adding a New Power Class

Lastly, there may be a method for defining a new power class supporting 27.8 dBm and 30 dBm such that the UE can use 27.8 dBm or 30 dBm as a new power class. For example, in addition to legacy power classes defined from 23 dBm (200 mW) to 29 dBm (800 mW) at a 3 dB interval with reference to handled UEs, the total power level that can be actually implemented, such as 27.8 dBm (600 mW) and 30 dBm (1000 mW), may be added as a new power class. The UE may then report UE capability thereof to the BS, based on a 200 mW-unit power class, and may calculate P_{CMAX} by configuring P_{PowerClass} based on the new power class. 27.8 dBm may be named a power class (for example, [power class 1.7]) between power class 2 and power class 1.5, and 30 dBm may be named a power class (for example, [power class 1.2]) between power class 1.5 and power class 1. For example, in such a method of adding a new power class, the UE may configure P_{PowerClass} based on the newly defined power class without changing the P_{PowerClass} configuration method when deriving P_{CMAX}. This may be applied not only to three-antenna transmission, but also to all cases in which the UE performs uplink transmission with multiple antennas. As an example, the same principle is applicable to a case involving four or more antennas.

### Third Embodiment: Method for Controlling Maximum Power Based on Total Output Available During Uplink Multi-Antenna Transmission

Hereinafter, P_{CMAX} definition methods for a UE to perform uplink transmission by using three PAs and antennas in a specific band will be described below. When the UE transmits an uplink by using multiple antennas, in order to derive P_{CMAX} based on the sum of outputs actually available, among the above-mentioned methods, a representative method may be used wherein new UE capability (for example, [higherPowerLimit-3Tx]) is reported to the BS, and P_{PowerClass} is based on the sum of each antenna output (power class). For example, the UE reports UE capability to the BS and derives P_{CMAX} by substituting the total sum of output values of three antennas for P_{PowerClass}, thereby deriving P_{CMAX}, such that the BS recognizes that the UE uses three antennas, and a P_{CMAX} value based on the sum power may be transmitted. The following description is based on method 2-1 as described above, but the UE may acquire P_{PowerClass} and P_{CMAX} based on a combination of at least one of methods 2-1 to 2-3. It is also possible to apply the following method in case that the UE determines new P_{PowerClass}, instead of methods 2-1 to 2-3.

The UE may configure the maximum output power regarding carrier f of support cell c. The UE's maximum rated output power configured in this manner is defined as P_{CMAX,f,c} (configured UE maximum output power), and this is determined by the UE within the boundary of upper and lower limits as follows:

$${P}_{CMAX \_ L , f , c} \leq {P}_{C M A X , f , c} \leq {P}_{CMAX \_ H , f , c} \qquad Equation 6$$

In Equation 6, the lower limit value P_{CMAX_L,f,c} and the upper limit value P_{CMAX_H,f,c} are determined as in Equation 7 and Equation 8, respectively.

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} \qquad Equation 7$$

$${P}_{CMAX \_ H , f , c} = MIN \{ {P}_{EMAX , c} , {P}_{PowerClass} - Δ {P}_{PowerClass} \} \qquad Equation 8$$

In Equation 7 and Equation 8, P_{EMAX,c} is a p-Max IE which is a BS configuration value defined in TS 38.331, or is a value based on regional regulations, such as the value of additional field additionalPmax in network signaling NR-NS-PmaxList IE.

In Equation 7 and Equation 8, P_{Powerclass} is a maximum UE power value defined as in the example of Table 12. If the UE supports [higherPowerLimit-3Tx], the P_{Powerclass} value is configured to be 27.8 dBm or 30 dBm according to reported UE capability.

Likewise, as mentioned in the second embodiment of the disclosure, the UE may determine P_{CMAX} based on various methods other than the antenna output (power class) sum-based method, or may update the UE power class table in connection with uplink transmission based on multiple antennas. Scenarios possible based on methods introduced in the second embodiment are summarized as follows. Table 12 describes a case in which UE capability supporting transmission using three PAs and antennas is added, and P_{Powerclass} is configured with reference to the power level added according to corresponding capability.

TABLE 17
The UE may configure maximum output power regarding carrier f of support
cell c. The UE's maximum rated output power configured in this manner is
defined as P_{CMAX,f,c} (configured UE maximum output power), and this is
determined by the UE within the boundary of upper and lower limits as in
Equation 9 below:

| | |
|---|---|
| P_{CMAX}_{_{—}}_{L,f,c} ≤ P_{CMAX,f,c} ≤ P_{CMAX}_{_{—}}_{H,f,c} | ... Equation 9 |

In Equation 9, the lower limit value P_{CMAX}_{_{—}}_{L,f,c} and the upper limit value
P_{CMAX}_{_{—}}_{H,f,c} are determined as in Equation 10 and Equation 11, respectively.
P_{CMAX}_{_{—}}_{L,f,c} = MIN { P_{EMAX,c}− ΔT_{C,c}, (P_{PowerClass} + P_{3Tx} − ΔP_{PowerClass}) −
MAX(MAX(MPR_{c}+ΔMPR_{c}, A-MPR_{c})+ ΔT_{IB,c} + ΔT_{C,c} + ΔT_{RxSRS}, P-MPR_{c})}

| | |
|---|---|
| | ... Equation 10 |
| P_{CMAX}_{_{—}}_{H,f,c} = MIN {P_{EMAX,c}, P_{PowerClass} + P_{3Tx} − ΔP_{PowerClass} } | ... Equation 11 |

In Equation 10 and Equation 11, P_{EMAX,c} is a p-Max IE which is a BS
configuration value defined in TS 38.331, or is a value based on regional
regulations, such as the value of additional field additionalPmax in network
signaling NR-NS-PmaxList IE.
In Equation 10 and Equation 11, P_{3Tx} is an additional output value during 3Tx
transmission. If the UE supports [higherPowerLimit-3Tx], + P_{3Tx} has 23dBm
or 26dBm according to reported UE capability.

On the other hand, in a method wherein the UE derives P_{CMAX} based on the total output actually available by adding a new power class, legacy P_{Powerclass} definition may be maintained, and a new power class may be added to the UE's band-specific power class table as in Table 18. Table 18 shows an example of bands that support uplink MIMO and band-specific power classes, and added power classes may be expanded and used for other power classes other than uplink MIMO. In addition, Table 18 may be the power class of a UE that supports uplink MIMO in a closed loop space multiplexing technique.

TABLE 18

| NR | Class 1.2³ | Tolerance | Class 1.5 | Tolerance | Class 1.7³ | Tolerance | Class 2 | Tolerance | Class 3 | Tolerance |
|---|---|---|---|---|---|---|---|---|---|---|
| band | (dBm) | (dB) | (dBm) | (dB) | (dBm) | (dB) | (dBm) | (dB) | (dBm) | (dB) |
| n1 | | | | | 27.8 | +2/−3 | 26 | +2/−3¹ | 23 | +2/−3 |
| n2 | | | | | | | | | 23 | +2/−3¹ |
| n3 | | | | | 27.8 | +2/−3 | 26 | +2/−3¹ | 23 | +2/−3¹ |
| n7 | | | | | | | | | 23 | +2/−3¹ |
| n8 | | | | | | | | | 23 | +2/−3¹ |
| n13 | | | | | | | | | 23 | +2/−3 |
| n24 | | | | | | | | | 23 | +2/−4¹ |
| n25 | | | | | | | | | 23 | +2/−3¹ |
| n28 | | | | | | | | | 23 | +2/−3¹ |
| n30 | | | | | | | | | 23 | +2/−3 |
| n34 | | | | | 27.8 | +2/−3 | 26 | +2/−3 | 23 | +2/−3 |
| n38 | | | | | | | | | 23 | +2/−3 |
| n39 | | | | | 27.8 | +2/−3 | 26 | +2/−3 | 23 | +2/−3 |
| n40 | | | | | 27.8 | +2/−3 | 26 | +2/−3¹ | 23 | +2/−3 |
| n41 | 30 | +2/−3 | 29 | +2/−3¹ | 27.8 | +2/−3 | 26 | +2/−3¹ | 23 | +2/−3¹ |
| n48 | | | | | | | | | 23 | +2/−3 |
| n66 | | | | | | | | | 23 | +2/−3 |
| n70 | | | | | | | | | 23 | +2/−3 |
| n71 | | | | | | | | | 23 | +2/−3 |
| n77 | 30 | +2/−3 | 29 | +2/−3 | 27.8 | +2/−3 | 26 | +2/−3 | 23 | +2/−3 |
| n78 | 30 | +2/−3 | 29 | +2/−3 | 27.8 | +2/−3 | 26 | +2/−3 | 23 | +2/−3 |
| n79 | 30 | +2/−3 | 29 | +2/−3 | 27.8 | +2/−3 | 26 | +2/−3 | 23 | +2/−3 |
| n80 | | | | | 27.8 | +2/−3 | 26 | +2/−3¹ | 23 | +2/−3¹ |
| n84 | | | | | 27.8 | +2/−3 | 26 | +2/−3¹ | 23 | +2/−3 |
| n95 | | | | | 27.8 | +2/−3 | 26 | +2/−3 | 23 | +2/−3 |
| n97 | | | | | 27.8 | +2/−3 | 26 | +2/−3 | 23 | +2/−3 |
| n98 | | | | | 27.8 | +2/−3 | 26 | +2/−3 | 23 | +2/−3 |
| n99 | | | | | | | | | 23 | +2/−4¹ |

NOTE 1:
The transmission bandwidths confined within F_{UL}_{_{—}}_{low} and F_{UL}_{_{—}}_{low} + 4 MHz or F_{UL}_{_{—}}_{high} − 4 MHz and F_{UL}_{_{—}}_{high}, the maximum output power requirement is relaxed by reducing the lower tolerance limit by 1.5 dB
NOTE 2:
Power class 3 is the default power class unless otherwise stated
NOTE 3:
This power class applies to 3-antenna-port codebook-based transmissions

As in Table 18, in case that a new power class is added to the power class of a UE that supports uplink MIMO in a closed loop space multiplexing technique, as mentioned in the previous embodiment of the disclosure, it is possible to add new power class 1.7 (27.8 dBm) during uplink transmission using three PAs and antennas in a legacy band supporting power class 2 (26 dBm) by using a maximum of two PAs and antennas. In addition, based on a similar ground, it is possible to add new power class 1.2 (30 dBm) during uplink transmission using three PAs and antennas in a legacy band supporting power class 2 (26 dBm) by using a maximum of two PAs and antennas. However, with regard to corresponding new power classes, the description that uplink transmission is performed using three PAs or three antenna ports or three layers needs to be added, as in NOTE 3 in Table 18.

### Fourth Embodiment: Method for Configuring Maximum Duty Cycle Available During Uplink Multi-Antenna Transmission

The following description will be directed to the maximum uplink duty cycle which is to be considered for each scenario when a UE performs high-output uplink transmission with a default power class (power class 3, 23 dBm) or higher using three PAs and antennas in a specific frequency band, and methods for improving the maximum uplink duty cycle to be performed to support uplink transmission through three antenna ports, based on the same, will be described below.

The time division duplex (TDD) scheme is a technology for separately operating the time intervals of the uplink and downlink. One frequency band is shared, the uplink is used for a predetermined time, and the uplink is used for another time, thereby enabling efficient frequency use. Therefore, the ratio between upload and download may be adjusted according to the situation, but in order to minimize the issue of interference with an adjacent frequency band, coming in a different link direction, use of TDD for mobile communication may have fixed downlink and uplink structures in a nation or region (for example, DDDSU). The ratio of the uplink against a predetermined frame or time which may occur in a determined TDD structure is referred to as an uplink duty cycle, and this may be defined in percentage terms (for example, the uplink duty cycle is 20% in a DDDSU frame structure).

The uplink duty cycle may also be used as a method for satisfying regulations regarding radio wave's influence on human bodies, when a UE performs high-output uplink transmission with a default power class (power class 3, 23 dBm) or higher, and a typical example thereof is “specific absorption rate (SAR)” which is regulated with reference to the average uplink output value for a predetermined time. For example, even if the UE performs high-output uplink transmission with a default power class or higher, the average output value for a predetermined time needs to be equal to/less than a specific regulation value. A UE that supports such high-output uplink transmission may calculate and manage the average output value with reference to the above-mentioned uplink duty cycle. For example, if a UE that supports power class 2 (26 dBm) has an uplink duty cycle of 50%, this may mean that the average value is the same as when a UE that supports power class 3 (23 dBm) performs transmission at an uplink duty cycle of 100%, and regulations (for example, SAR) are satisfied. Based thereon, in case that the UE supports high-output uplink transmission with power class 2 or higher in a specific band, maximum uplink duty cycle UE capability is defined as follows according to each scenario, and the UE may, if necessary, report corresponding UE capability to the BS.

### [Example 4-1] in Case that Power Class 2 is Supported

A UE that supports power class 2 may report UE capability maxUplinkDutyCycle-PC2-FR1, and may report one of n60, n70, n80, n90, and n100 according to corresponding UE capability. n60 means that, if uplink symbols scheduled by the BS during a specific measurement interval correspond to 60% or higher, the UE may fall back to the default power class (power class 3). Similarly, if the UE reports n70, this means that, if uplink symbols scheduled by the BS during a specific measurement interval correspond to 70% or higher, the UE may fall back to the default power class (power class 3). However, it is assumed that, unless corresponding UE capability is reported, the UE's maximum uplink duty cycle is 50%.

### [Example 4-2] in Case that Power Class 1.5 is Supported

A UE that supports power class 1.5 may also report UE capability maxUplinkDutyCycle-PC2-FR1, and basically operates with reference to max UplinkDutyCycle-PC2-FR1/2. For example, the UE may operate similarly to a power class 2 UE and may report one of n60, n70, n80, n90, and n100 according to corresponding UE capability. If the UE reports n60 (that is 60%), this means that, with reference to 30% (half the same), if uplink symbols scheduled by the BS during a specific measurement interval correspond to 30% or higher, the UE may fall back to a lower power class (power class 2). Similarly, if the UE reports n70, this means that, with reference to 35% (half the same), if uplink symbols scheduled by the BS during a specific measurement interval correspond to 35% or higher, the UE may fall back to a lower power class (power class 2). However, it is assumed that, if uplink symbols scheduled by the BS during a specific measurement interval correspond to 50% or higher, the UE instantly falls back to the default power class (power class 3).

In addition, assuming that the UE can perform uplink transmission with a new output value through methods included in the previous embodiment of the disclosure, the UE needs to adjust the uplink output value based on new duty cycle UE capability appropriate for the new output value. On the other hand, if the same legacy uplink duty cycle limitation is used, the UE may back off or fall back the UE power due to the duty cycle limitation which is more than necessary, thereby failing to secure sufficient performance improvement such that uplink transmission can be performed with three or more antenna ports (for example, in case that 27.8 dBm output is subjected to 25% uplink duty cycle limitation, such as power class 1.5). In contrast, regulations may be violated due to alleviated uplink duty cycle conditions (for example, in case that 27.8 dBm output is subjected to 50% uplink duty cycle limitation, such as power class 2).

As a method for addressing such issues, it may be considered to use maximum uplink duty cycle-related UE capability (that is, maxUplinkDutyCycle-PC2-FR1) based on legacy power class 2, or to use a new formulate regarding the maximum uplink duty cycle. In addition, it may also be considered to define new UE capability for a new UE power class. As described above, the upper and lower limits of legacy P_{CMAX} are derived with reference to P_{PowerClass} and ΔP_{PowerClass} which are indicators based on the band-specific power class available to the UE, and ΔP_{PowerClass} among the same follows maximum uplink duty cycle-related UE capability predefined with regard to each power class of the UE. For example, the UE and BS may consider that, in order to determine maximum P_{CMAX} that the UE can transmit, the ΔP_{PowerClass} based on uplink duty cycle-related UE capability is defined by a combination of at least one of the following various methods:

### [Method 4-1] Using Maximum Uplink Duty Cycle-Related UE Capability Based on Power Class 2

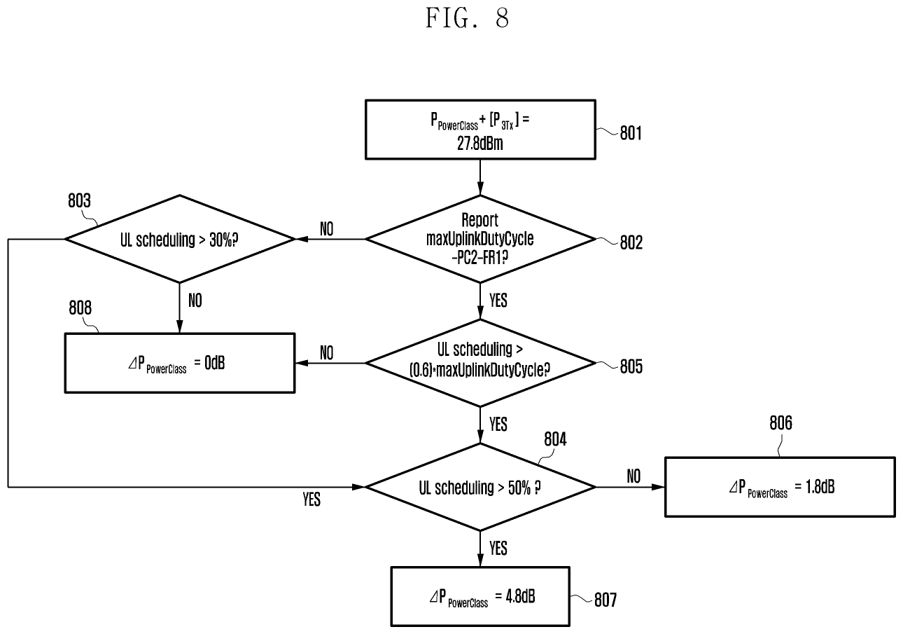

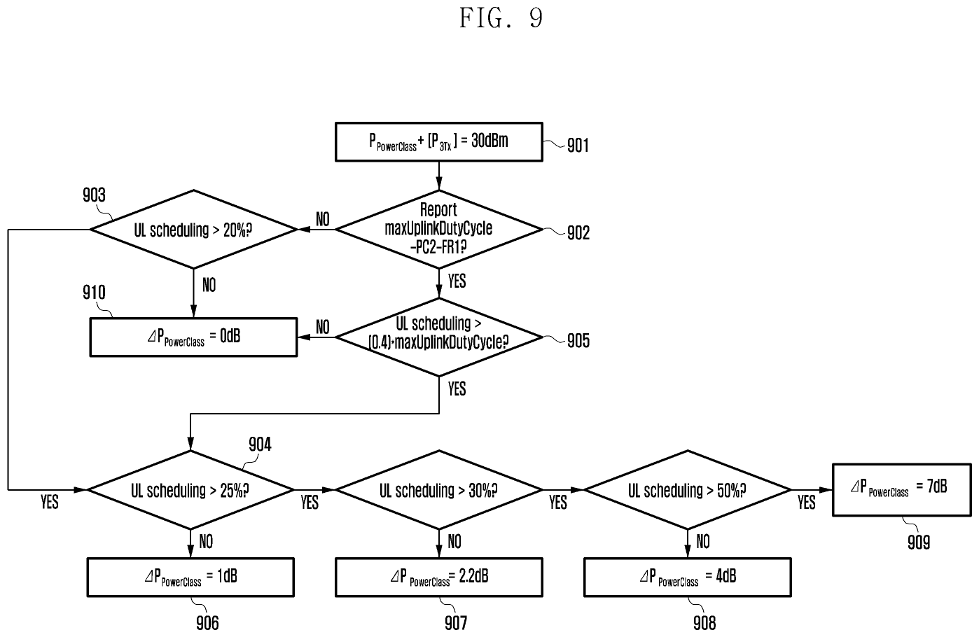

As described above, the UE may transmit an uplink signal by using three PAs and antennas as in FIGS. 8 and 9 and, if a new output value that is absent among legacy power classes is available, may use the same as new UE capability ([higherPowerLimit-3Tx]), thereby deriving P_{Powerclass} or P_{Powerclass}+[P_{3Tx}] based on the total sum of output values from three antennas instead.

FIG. 8 illustrates a method in which a UE adjusts a maximum rated output value by using maximum uplink duty cycle-related UE capability based on power class 2 according to an embodiment of the disclosure.

Referring to FIG. 8, if the UE's P_{Powerclass} or P_{Powerclass}+[P_{3Tx}] value is changed to a new output value, that is 27.8 dBm or 30 dBm, based on a combination of at least one of the above-described embodiments' methods, the UE may also drive the ΔP_{PowerClass} value based on a new reference. For example, assuming that the P_{Powerclass} or P_{Powerclass}+[P_{3Tx}] value is configured to be 27.8 dBm and reported to the BS in operation 801, the UE may determine whether or not to report maxUplinkDutyCycle-PC2-FR1 to the BS in operation 802. Capability reporting in operations 801 and 302 may be performed together.

In case that the UE does not report maxUplinkDutyCycle-PC2-FR1, the UE's maximum uplink duty cycle's default value may be about 30%. The UE determines whether the scheduled uplink ratio exceeds 30% in operation 803. If the scheduled uplink ratio exceeds 30%, ΔP_{PowerClass} may be 0 dB in operation 808.

In case that the UE has reported maxUplinkDutyCycle-PC2-FR1, the UE determines whether uplink transmission (or uplink symbol) equal to/higher than (0.6)*maxUplinkDutyCycle-PC2-FR1 has been scheduled or not in operation 805. If uplink transmission (or symbol) uplink equal to/higher than (0.6)*maxUplinkDutyCycle-PC2-FR1 has been not scheduled, ΔP_{PowerClass} may be 0 dB in operation 808.

If the BS schedules the uplink at a ratio of 30% or higher for a specific time, or schedules uplink transmission (or uplink symbol) equal to/higher than (0.6)*maxUplinkDutyCycle-PC2-FR1 in operations 804 and 805, the UE may fall back to a lower UE power class according to the scheduled uplink ratio in operations 806 and 807. For example, if the uplink ratio is between 30% and 50%, ΔP_{PowerClass} becomes 1.8 dB, and the UE may fall back to power class 2 (26 dBm) in operation 806. If the BS allocates an uplink ratio of 50% or higher, ΔP_{PowerClass} becomes 4.8 dB, and the UE may fall back to power class 3 (23 dBm) in operation 807.

Above-described values are only examples, and applying other values is also sufficiently possible. The above-described flowchart illustrates a method that may be implemented according to the disclosure's principle, and the method illustrated in the flowchart in the specification may be variously modified. For example, although illustrated as a series of steps, various steps in respective drawings may overlap, occur in parallel, occur in a different order, or occur multiple times. In another example, steps may be omitted or replaced with other steps.

FIG. 9 illustrates a method in which a UE adjusts a maximum rated output value by using maximum uplink duty cycle-related UE capability based on power class 2 according to an embodiment of the disclosure.

Referring to FIG. 9, similarly, assuming that the P_{Powerclass} Or P_{Powerclass}+[P_{3Tx}] value is configured to be 30 dBm, based on a combination of at least one of the above-described embodiments' methods, and reported by the UE to the BS in operation 901, the UE may determine whether or not to report maxUplinkDutyCycle-PC2-FR1 to the BS in operation 902. In case that the UE does not report maxUplinkDutyCycle-PC2-FR1, the UE's maximum uplink duty cycle's default value may be about 20%. The UE determines whether the scheduled uplink ratio exceeds 20% in operation 903 and, if so, ΔP_{PowerClass} is determined to be 0 dB in operation 910. If 20% is not exceeded, the UE proceeds to operation 904.

In case that the UE has reported maxUplinkDutyCycle-PC2-FR1, the UE determines whether uplink transmission (or uplink symbol) equal to/higher than (0.4)*maxUplinkDutyCycle-PC2-FR1 has been scheduled or not in operation 905. If uplink transmission (or symbol) uplink equal to/higher than (0.4)*maxUplinkDutyCycle-PC2-FR1 has been not scheduled, ΔP_{PowerClass} is determined to be 0 dB in operation 910.

If the BS schedules the uplink at a ratio of 20% or higher for a specific time, or schedules uplink transmission (or uplink symbol) equal to/higher than (0.4)*maxUplinkDutyCycle-PC2-FR1 in operations 904 and 905, the UE may fall back to a lower UE power class according to the scheduled uplink ratio in operations 906, 907, 908, and 909. For example, if BS schedules the uplink ratio is between 20% and 25%, ΔP_{PowerClass} becomes 1 dB, and the UE falls back to power class 1.5 (29 dBm) in operation 906. If the uplink ratio is between 25% and 30%, ΔP_{PowerClass} becomes 2.2 dB, and the UE falls back to 27.8 dBm in operation 907. If the uplink ratio is between 30% and 50%, ΔP_{PowerClass} becomes 4 dB, and the UE may fall back to power class 2 (26 dBm) in operation 908. Lastly, if the BS allocates an uplink ratio of 50% or higher, ΔP_{PowerClass} becomes 7 dB, and the UE may fall back to power class 3 (23 dBm) in operation 909. The ΔP_{PowerClass} value may be defined as the difference between the current P_{Powerclass} value and the power level to which the UE falls back.

Above-described values are only examples, and applying other values is also sufficiently possible. The above-described flowchart illustrates a method that may be implemented according to the disclosure's principle, and the method illustrated in the flowchart in the specification may be variously modified. For example, although illustrated as a series of steps, various steps in respective drawings may overlap, occur in parallel, occur in a different order, or occur multiple times. In another example, steps may be omitted or replaced with other steps.

### [Method 4-2] Method of Adding New UE Capability

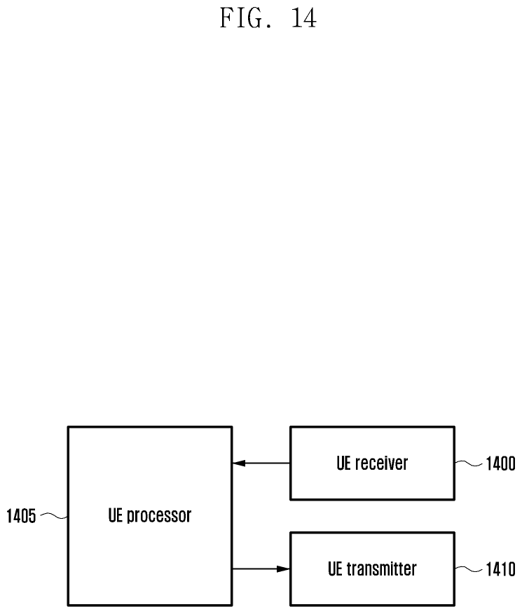

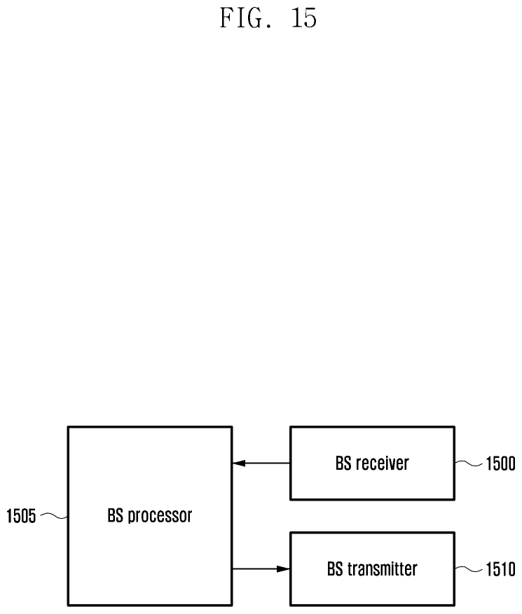

In another method, as in FIGS. 14 and 15, new UE capability may be defined such that the UE can configure a new fallback reference appropriate for previously absent uplink output values, such as 27.8 dBm, 30 dBm.

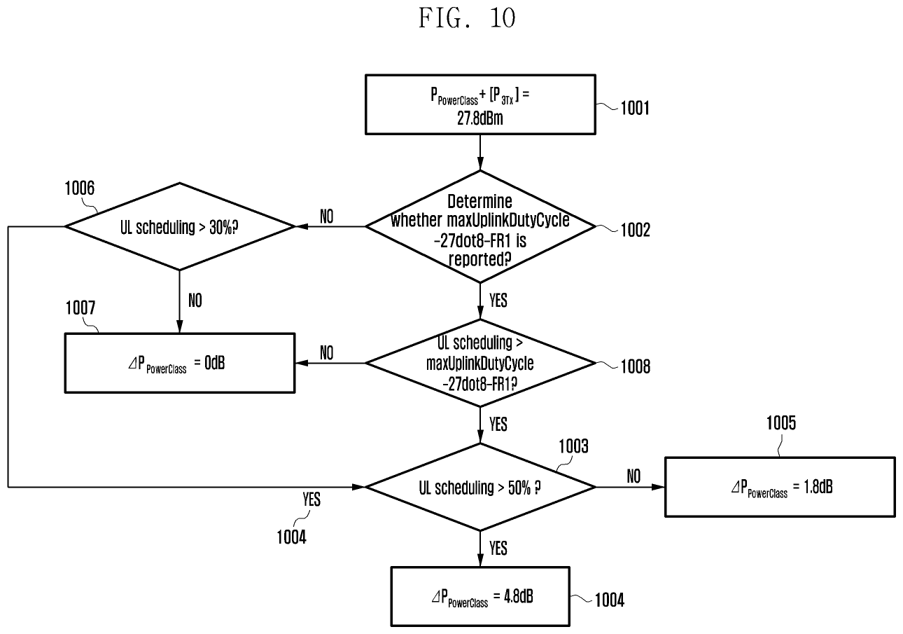

FIG. 10 illustrates a method in which a UE adjusts a maximum rated output value by using new maximum uplink duty cycle-related UE capability according to an embodiment of the disclosure.

Referring to FIG. 10, for example, in case that the UE has configured the P_{Powerclass} Or P_{Powerclass}+[P_{3Tx}] value for configuring the P_{CMAX} value to be 27.8 dBm in operation 1001, based on a combination of at least one of the above-described embodiments' methods, the UE determines whether or not to report one of field values that new UE capability (for example, maxUplinkDutyCycle-27dot8-FR1) has, to the BS in operation 1002. The field value that maxUplinkDutyCycle-27dot8-FR1 has may be configured to be 30% 1406, 40%, 50%, 60%, 70%, 80%, 90%, 100%, or the like. In case that the UE reports maxUplinkDutyCycle-27dot8-FR1, the UE determines the uplink ratio scheduled by the BS within a predetermined time with reference to the reported field value in operation 1008.

In case that the scheduled uplink ratio is larger than maxUplinkDutyCycle-27dot8-FR1, the UE may adjust the ΔP_{PowerClass} value according to the scheduled uplink ratio, thereby configuring a reference to fall back to a lower output level. As an example, the UE may determine whether the uplink ratio exceeds 50% in operation 1008. In case that the uplink ratio is lower than 50%, ΔP_{PowerClass} becomes 1.8 dB, and the UE may fall back to power class 2 (26 dBm) in operation 1005. If it is determined in operation 1003 that the BS allocates an uplink ratio of 50% or higher, ΔP_{PowerClass} becomes 4.8 dB in operation 1009, and the UE may fall back to power class 3 (23 dBm) in operation 1004. In case that the scheduled uplink ratio is not larger than maxUplinkDutyCycle-27dot8-FR1, ΔP_{PowerClass} becomes 0 dB in operation 1007.

In case that the UE does not report maxUplinkDutyCycle-27dot8-FR1, the UE's maximum uplink duty cycle's default value may be about 30%. The UE may determine whether the scheduled uplink ratio is larger than 30% in operation 1006. If the scheduled uplink ratio is larger than 30%, the UE proceeds to operation 1008. If the scheduled uplink ratio is smaller than 30%, ΔP_{PowerClass} becomes 0 dB in operation 1007.

Above-described values are only examples, and applying other values is also sufficiently possible. The above-described flowchart illustrates a method that may be implemented according to the disclosure's principle, and the method illustrated in the flowchart in the specification may be variously modified. For example, although illustrated as a series of steps, various steps in respective drawings may overlap, occur in parallel, occur in a different order, or occur multiple times. In another example, steps may be omitted or replaced with other steps.

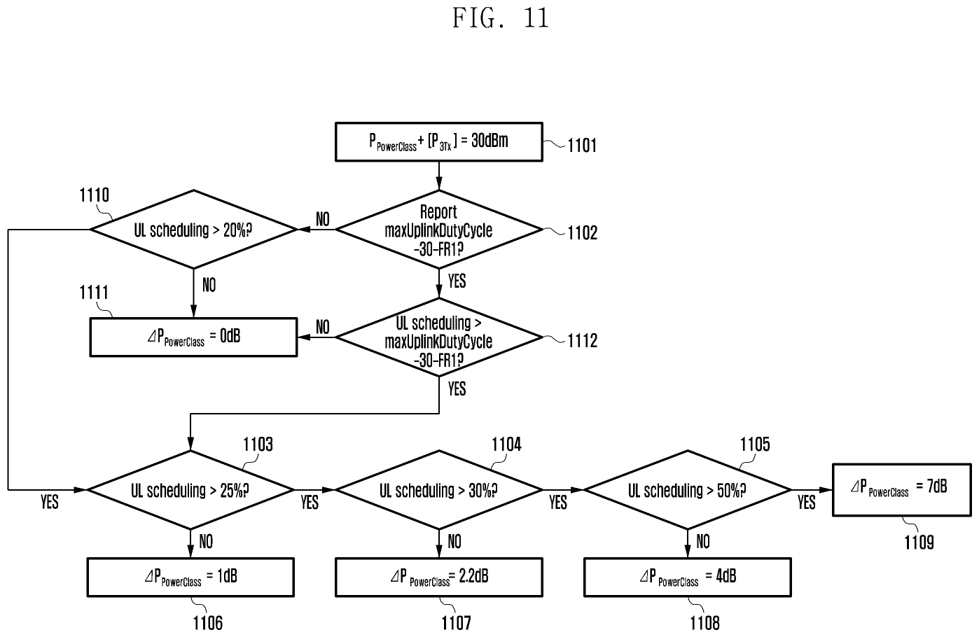

FIG. 11 illustrates a method in which a UE adjusts a maximum rated output value by using new maximum uplink duty cycle-related UE capability according to an embodiment of the disclosure.

Referring to FIG. 11, for example, in case that the UE has configured the P_{Powerclass} or P_{Powerclass}+[P_{3Tx}] to be 30 dBm in operation 1101, based on a combination of at least one of the above-described embodiments' methods, the UE determines whether or not to report one of field values that new UE capability (for example, maxUplinkDutyCycle-30-FR1) has, to the BS in operation 1102. The field value that maxUplinkDutyCycle-30-FR1 has may be configured to be 20%, 30%, 40%, 50%, 60%, 70%, 80%, 90%, 100%, or the like. In case that the UE reports maxUplinkDutyCycle-30-FR1, the UE determines the uplink ratio scheduled by the BS within a predetermined time is larger than the reported field value with reference to the reported field value in operation 1112. If the scheduled uplink ratio is larger than the reported field value, ΔP_{PowerClass} is determined according to the scheduled uplink ratio. Such determinations may be made successively or at once. As an example, in case that the uplink ratio is 25% or less, ΔP_{PowerClass} becomes 1.8 dB in operation 1106. If it is determined in operation 1003 that the uplink ratio is above 25% and is 30% or less, ΔP_{PowerClass} becomes 2.2 dB in operation 1107. If it is determined in operation 1004 that the uplink ratio is above 30% and is 50% or less, ΔP_{PowerClass} becomes 4 dB in operation 1108. If it is determined in operation 1005 that the uplink ratio is above 50%, ΔP_{PowerClass} becomes 4 dB in operation 1109. As described above, the UE may adjust the ΔP_{PowerClass} value so as to configure a reference to fall back to a lower output level. For example, in case that the uplink ratio scheduled for the UE by the BS for a predetermined time is higher than the maximum uplink duty cycle value reported to the BS by the UE, ΔP_{PowerClass} may be adjusted according to the actual uplink ratio.

In case that the UE does not report maxUplinkDutyCycle-30-FR1, the UE's maximum uplink duty cycle's default value may be about 20%, and the UE compares the uplink ratio and 20% in operation 1110. In this case, in case that the uplink ratio is 20% or less, the ΔP_{PowerClass} value may be 0 dB in operation 1111. If the uplink ratio is above 20%, the UE proceeds to operation 1103.

Above-described values are only examples, and applying other values is also sufficiently possible. The above-described flowchart illustrates a method that may be implemented according to the disclosure's principle, and the method illustrated in the flowchart in the specification may be variously modified. For example, although illustrated as a series of steps, various steps in respective drawings may overlap, occur in parallel, occur in a different order, or occur multiple times. In another example, steps may be omitted or replaced with other steps.

### Fifth Embodiment: Method for Controlling Maximum Power Based on Available Maximum Duty Cycle During Uplink Multi-Antenna Transmission

Hereinafter, methods for defining ΔP_{PowerClass} and P_{CMAX} so as to reflect a new fallback reference configured by a UE in accordance with previously absent uplink output values (for example, 27.8 dBm, 30 dBm) will be described below.

When a UE transmits an uplink by using three PAs and antennas in a specific band, in order to derive P_{CMAX} based on the sum of outputs actually available and an appropriate fallback operation, a representative method based on maximum uplink duty cycle-related UE capability based on legacy power class 2, among the above-mentioned methods, may be used. For example, according to the UE's power class or sum output value, if the P_{PowerClass} value is configured to be 27.8 dBm as below, the UE may configure the ΔP_{PowerClass} value based on (0.6)*maxUplinkDutyCycle-PC2-FR1. If the P_{PowerClass} value is configured to be 30 dBm, the UE may configure the ΔP_{PowerClass} value according to (0.4)*maxUplinkDutyCycle-PC2-FR1.

In relation to ΔP_{PowerClass}:

In the next case, a UE that supports power class 2 may be configured to 3 dB, a UE that supports power class 1.5 may be configured to 6 dB, a UE the P_{Powerclass} or P_{PowerClass}+[P_{3Tx}] value of which is 27.8 dBm may be configured to 4.8 dB, and a UE the P_{Powerclass} or P_{PowerClass}+[P_{3Tx}] value of which is 30 dBm may be configured to 7 dB. The next case is as follows:

In case that the BS has configured the P_{CMAX} value to be 23 dB or lower, or in case that the field of UE capability maxUplinkDutyCycle-PC2-FR1 is empty, maxUplinkDutyCycle-PCIdot5-MPE-FR1 is empty, and the ratio of uplink symbols transmitted for a predetermined measurement time is larger than 50%,
Or in case that, as defined in TS 38.306 (the exact measurement time is longer than one radio wave frame), the field of UE capability maxUplinkDutyCycle-PC2-FR1 is not empty, and the ratio of uplink symbols transmitted for a predetermined measurement time is larger than maxUplinkDutyCycle-PC2-FR1,
Or in case that, as defined in TS 38.306 (the exact measurement time is longer than one radio wave frame), the field of UE capability maxUplinkDutyCycle-PCIdot5-MPE-FR1 is not empty, and half the ratio of uplink symbols transmitted for a predetermined measurement time is larger than maxUplinkDutyCycle-PCIdot5-MPE-FR1.

In the next case, a UE that supports power class 1.5 may be configured to 3 dB, a UE the P_{Powerclass} or P_{PowerClass}+[P_{3Tx}] value of which is 27.8 dBm may be configured to 1.8 dB, and a UE the P_{Powerclass} or P_{PowerClass}+[P_{3Tx}] value of which is 30 dBm may be configured to 4 dB. The next case is as follows:
In case that the BS has configured the P_{CMAX} value to be between 23 dBm and 26 dBm,
Or in case that the field of UE capability maxUplinkDutyCycle-PC2-FR1 is empty, maxUplinkDutyCycle-PCIdot5-MPE-FR1 is empty, and the ratio of uplink symbols transmitted for a predetermined measurement time is between 30% and 50%,
Or in case that, as defined in TS 38.306 (the exact measurement time is longer than one radio wave frame), the field of UE capability maxUplinkDutyCycle-PC2-FR1 is not empty, and the ratio of uplink symbols transmitted for a predetermined measurement time is between maxUplinkDutyCycle-PC2-FR1 and maxUplinkDutyCycle-PC2-FR1*0.6,
Or in case that, as defined in TS 38.306 (the exact measurement time is longer than one radio wave frame), the field of UE capability maxUplinkDutyCycle-PCIdot5-MPE-FR1 is not empty, and half the ratio of uplink symbols transmitted for a predetermined measurement time is larger than maxUplinkDutyCycle-PCIdot5-MPE-FR1.

In the next case, a UE that supports power class 1.5 may be configured to 1.2 dB, and a UE the P_{Powerclass} or P_{PowerClass}+[P_{3Tx}] value of which is 30 dBm may be configured to 2.2 dB. The next case is as follows:
In case that the BS has configured the P-max value to be between 26 dBm and 27.8 dBm,
Or in case that the field of UE capability maxUplinkDutyCycle-PC2-FR1 is empty, maxUplinkDutyCycle-PCIdot5-MPE-FR1 is empty, and the ratio of uplink symbols transmitted for a predetermined measurement time is between 25% and 30%,
Or in case that, as defined in TS 38.306 (the exact measurement time is longer than one radio wave frame), the field of UE capability maxUplinkDutyCycle-PC2-FR1 is not empty, and the ratio of uplink symbols transmitted for a predetermined measurement time is between maxUplinkDutyCycle-PC2-FR1 0.6 and maxUplinkDutyCycle-PC2-FR1/2,
Or in case that, as defined in TS 38.306 (the exact measurement time is longer than one radio wave frame), the field of UE capability maxUplinkDutyCycle-PCIdot5-MPE-FR1 is not empty, and the ratio of uplink symbols transmitted for a predetermined measurement time is larger than maxUplinkDutyCycle-PCIdot5-MPE-FR1*1.2.

In the next case, a UE the P_{Powerclass} or P_{PowerClass}+[P_{3Tx}] value of which is 30 dBm may be configured to 1 dB. The next case is as follows:
In case that the BS has configured the P-max value to be between 27.8 dBm and 29 dBm, or in case that the field of UE capability maxUplinkDutyCycle-PC2-FR1 is empty, and the ratio of uplink symbols transmitted for a predetermined measurement time is between 20% and 25%,
Or in case that, as defined in TS 38.306 (the exact measurement time is longer than one radio wave frame), the field of UE capability maxUplinkDutyCycle-PC2-FR1 is not empty, and the ratio of uplink symbols transmitted for a predetermined measurement time is between maxUplinkDutyCycle-PC2-FR1*0.5 and maxUplinkDutyCycle-PC2-FR1*0.4.

Likewise, as mentioned in the fourth embodiment of the disclosure, the UE may also introduce new UE capability related to the maximum uplink duty cycle so as to adjust the ΔP_{PowerClass} value regarding a new power level. Moreover, as mentioned in the second embodiment of the disclosure, when the UE performs uplink transmission by using three PAs and antennas and derives P_{CMAX}, the UE may define a new power class supporting the corresponding sum output value as in [Method 2-3]. As such, various scenarios are possible through a combination between methods mentioned in the second and fourth embodiments of the disclosure, and such scenarios are summarized as follows.

Table 19 corresponds to a case in which a new power class that supports 27.8 dBm or 30 dBm is defined, and ΔP_{PowerClass} of P_{CMAX} is configured by the legacy method based on maximum uplink duty cycle-related UE capability based on power class 2.

TABLE 19
In relation to ΔP_{PowerClass}
- In the next case, a UE that supports power class 2 may be configured to 3dB,
a UE that supports power class 1.5 may be configured to 6dB, a UE that
supports power class 1.7 may be configured to 4.8dB, and a UE that supports
power class 1.2 may be configured to 7dB. In case that the BS has configured
the P-max value to be 23dBm or lower, or in case that the field of UE
capability maxUplinkDutyCycle-PC2-FR1 is empty, maxUplinkDutyCycle-
PC1dot5-MPE-FR1 is empty, and the ratio of uplink symbols transmitted for a
predetermined measurement time is larger than 50%, or in case that, as defined
in TS 38.306 (the exact measurement time is longer than one radio wave
frame), the field of UE capability maxUplinkDutyCycle-PC2-FR1 is not empty,
and the ratio of uplink symbols transmitted for a predetermined measurement
time is larger than maxUplinkDutyCycle-PC2-FR1, or in case that, as defined
in TS 38.306 (the exact measurement time is longer than one radio wave
frame), the field of UE capability maxUplinkDutyCycle-PC1dot5-MPE-FR1 is
not empty, and half the ratio of uplink symbols transmitted for a predetermined
measurement time is larger than maxUplinkDutyCycle-PC1dot5-MPE-FR1.
- In the next case, a UE that supports power class 1.5 may be configured to
3dB, a UE that supports power class 1.7 may be configured to 1.8dB, and a UE
that supports power class 1.2 may be configured to 4dB. In case that the BS
has configured the P-max to be between 23dBm and 26dBm, or in case that the
field of UE capability maxUplinkDutyCycle-PC2-FR1 is empty,
maxUplinkDutyCycle-PC1dot5-MPE-FR1 is empty, and the ratio of uplink
symbols transmitted for a predetermined measurement time is between 30%
and 50%, or in case that, as defined in TS 38.306 (the exact measurement time
is longer than one radio wave frame), the field of UE capability
maxUplinkDutyCycle-PC2-FR1 is not empty, and the ratio of uplink symbols
transmitted for a predetermined measurement time is between
maxUplinkDutyCycle-PC2-FR1 and maxUplinkDutyCycle-PC2-FR1 * 0.6, or
in case that, as defined in TS 38.306 (the exact measurement time is longer
than one radio wave frame), the field of UE capability maxUplinkDutyCycle-
PC1dot5-MPE-FR1 is not empty, and half the ratio of uplink symbols
transmitted for a predetermined measurement time is larger than
maxUplinkDutyCycle-PC1dot5-MPE-FR1.
- In the next case, a UE that supports power class 1.5 may be configured to
1.2dB, and a UE that supports power class 1.2 may be configured to 2.2dB. In
case that the BS has configured the P-max value to be between 26dBm and
27.8dBm, or in case that the field of UE capability maxUplinkDutyCycle-PC2-
FR1 is empty, maxUplinkDutyCycle-PC1dot5-MPE-FR1 is empty, and the
ratio of uplink symbols transmitted for a predetermined measurement time is
between 25% and 30%, or in case that, as defined in TS 38.306 (the exact
measurement time is longer than one radio wave frame), the field of UE
capability maxUplinkDutyCycle-PC2-FR1 is not empty, and the ratio of uplink
symbols transmitted for a predetermined measurement time is between
maxUplinkDutyCycle-PC2-FR1 * 0.6 and maxUplinkDutyCycle-PC2-FR1 / 2,
or in case that, as defined in TS 38.306 (the exact measurement time is longer
than one radio wave frame), the field of UE capability maxUplinkDutyCycle-
PC1dot5-MPE-FR1 is not empty, and the ratio of uplink symbols transmitted
for a predetermined measurement time is larger than maxUplinkDutyCycle-
PC1dot5-MPE-FR1 * 1.2.
- In the next case, a UE that supports power class 1.2 may be configured to
1dB. In case that the BS has configured the P-max value to be between
27.8dBm and 29dBm, or in case that the field of UE capability
maxUplinkDutyCycle-PC2-FR1 is empty, and the ratio of uplink symbols
transmitted for a predetermined measurement time is between 20% and 25%,
or in case that, as defined in TS 38.306 (the exact measurement time is longer
than one radio wave frame), the field of UE capability maxUplinkDutyCycle-
PC2-FR1 is not empty, and the ratio of uplink symbols transmitted for a
predetermined measurement time is between maxUplinkDutyCycle-PC2-FR1
0.5 and maxUplinkDutyCycle-PC2-FR1 * 0.4.

Table 20 corresponds to a case in which a UE configures a new maximum output by a ΔP_{PowerClass} replacement method based on the total sum of outputs from three antennas, and configures ΔP_{PowerClass} of P_{CMAX} by a method of adding new UE capability related to the maximum uplink duty cycle.

TABLE 20
In relation to ΔP_{PowerClass}
- In the next case, a UE that supports power class 2 may be configured to 3dB,
a UE that supports power class 1.5 may be configured to 6dB, a UE the
P_{PowerClass} Or P_{PowerClass} + [P_{3Tx}] value of which is 27.8dBm may be configured to
4.8dB, and a UE the P_{PowerClass} or P_{PowerClass} + [P_{3Tx}] value of which is 30dBm
may be configured to 7dB. In case that the BS has configured the P-max value
to be 23dB or lower, or in case that the field of UE capability
maxUplinkDutyCycle-PC2-FR1 is empty, maxUplinkDutyCycle-PC1dot5-
MPE-FR1 is empty, maxUplinkDutyCycle-27dot8-FR1 is empty,
maxUplinkDutyCycle-30-FR1 is empty, and the ratio of uplink symbols
transmitted for a predetermined measurement time is larger than 50%, or in
case that, as defined in TS 38.306 (the exact measurement time is longer than
one radio wave frame), the field of UE capability maxUplinkDutyCycle-PC2-
FR1 is not empty, and the ratio of uplink symbols transmitted for a
predetermined measurement time is larger than maxUplinkDutyCycle-PC2-
FR1, or in case that, as defined in TS 38.306 (the exact measurement time is
longer than one radio wave frame), the field of UE capability
maxUplinkDutyCycle-PC1dot5-MPE-FR1 is not empty, and half the ratio of
uplink symbols transmitted for a predetermined measurement time is larger
than maxUplinkDutyCycle-PC1dot5-MPE-FR1, or in case that, as defined in
TS 38.306 (the exact measurement time is longer than one radio wave frame),
the field of UE capability maxUplinkDutyCycle-27dot8-FR1 is not empty, and
60% of the ratio of uplink symbols transmitted for a predetermined
measurement time is larger than maxUplinkDutyCycle-27dot8-FR1, or in case
that, as defined in TS 38.306 (the exact measurement time is longer than one
radio wave frame), the field of UE capability maxUplinkDutyCycle-30-FR1 is
not empty, and 40% of the ratio of uplink symbols transmitted for a
predetermined measurement time is larger than maxUplinkDutyCycle-30-FR1.
- In the next case, a UE that supports power class 1.5 may be configured to
3dB, a UE the P_{PowerClass} or P_{PowerClass} + [P_{3Tx}] value of which is 27.8dBm may
be configured to 1.8dB, and a UE the P_{PowerClass} or P_{PowerClass} + [P_{3Tx}] value of
which is 30dBm may be configured to 4dB. In case that the BS has configured
the P-max to be between 23dBm and 26dBm, or in case that the field of UE
capability maxUplinkDutyCycle-PC2-FR1 is empty, maxUplinkDutyCycle-
PC1dot5-MPE-FR1 is empty, maxUplinkDutyCycle-27dot8-FR1 is empty,
maxUplinkDutyCycle-30-FR1 is empty, and the ratio of uplink symbols
transmitted for a predetermined measurement time is between 30% and 50%,
or in case that, as defined in TS 38.306 (the exact measurement time is longer
than one radio wave frame), the field of UE capability maxUplinkDutyCycle-
PC2-FR1 is not empty, and the ratio of uplink symbols transmitted for a
predetermined measurement time is between maxUplinkDutyCycle-PC2-FR1
and maxUplinkDutyCycle-PC2-FR1 * 0.6, or in case that, as defined in TS
38.306 (the exact measurement time is longer than one radio wave frame), the
field of UE capability maxUplinkDutyCycle-PC1dot5-MPE-FR1 is not empty,
and the ratio of uplink symbols transmitted for a predetermined measurement
time is larger than maxUplinkDutyCycle-PC1dot5-MPE-FR1, or in case that,
as defined in TS 38.306 (the exact measurement time is longer than one radio
wave frame), the field of UE capability maxUplinkDutyCycle-27dot8-FR1 is
not empty, and half the ratio of uplink symbols transmitted for a predetermined
measurement time is larger than maxUplinkDutyCycle-27dot8-FR1, or in case
that, as defined in TS 38.306 (the exact measurement time is longer than one
radio wave frame), the field of UE capability maxUplinkDutyCycle-30-FR1 is
not empty, and the ratio of uplink symbols transmitted for a predetermined
measurement time is between maxUplinkDutyCycle-30-FR1 * (2.5) and
maxUplinkDutyCycle-30-FR1 * (1.5). In the next case, a UE that supports
power class 1.5 may be configured to 1.2dB, and a UE the PPowerClass or
PPowerClass + [P_{3Tx}] value of which is 30dBm may be configured to 2.2dB.
In case that the BS has configured the P-max to be between 26dBm and
27.8dBm, or in case that the field of UE capability maxUplinkDutyCycle-PC2-
FR1 is empty, maxUplinkDutyCycle-PC1dot5-MPE-FR1 is empty,
maxUplinkDutyCycle-30-FR1 is empty, and the ratio of uplink symbols
transmitted for a predetermined measurement time is between 25% and 30%,
or in case that, as defined in TS 38.306 (the exact measurement time is longer
than one radio wave frame), the field of UE capability maxUplinkDutyCycle-
PC2-FR1 is not empty, and the ratio of uplink symbols transmitted for a
predetermined measurement time is between maxUplinkDutyCycle-PC2-FR1 *
0.6 and maxUplinkDutyCycle-PC2-FR1 / 2, or in case that, as defined in TS
38.306 (the exact measurement time is longer than one radio wave frame), the
field of UE capability maxUplinkDutyCycle-PC1dot5-MPE-FR1 is not empty,
and the ratio of uplink symbols transmitted for a predetermined measurement
time is larger than maxUplinkDutyCycle-PC1dot5-MPE-FR1 * (1.2), or in case
that, as defined in TS 38.306 (the exact measurement time is longer than one
radio wave frame), the field of UE capability maxUplinkDutyCycle-30-FR1 is
not empty, and the ratio of uplink symbols transmitted for a predetermined
measurement time is between maxUplinkDutyCycle-30-FR1 * (1.5) and
maxUplinkDutyCycle-30-FR1 * (1.25).
- In the next case, a UE the P_{PowerClass} or P_{PowerClass} + [P_{3Tx}] value of which is
30dBm may be configured to 1dB. In case that the BS has configured the P-
max to be between 27.8dBm and 29dBm, or in case that UE capability
maxUplinkDutyCycle-30-FR1 is empty, and the ratio of uplink symbols
transmitted for a predetermined measurement time is between 20% and 25%,
or in case that, as defined in TS 38.306 (the exact measurement time is longer
than one radio wave frame), the field of UE capability maxUplinkDutyCycle-
30-FR1 is not empty, and the ratio of uplink symbols transmitted for a
predetermined measurement time is larger than maxUplinkDutyCycle-30-FR1.

Table 21 corresponds to a case in which a new power class that supports 27.8 dBm or 30 dBm is defined, and ΔP_{PowerClass} of P_{CMAX} is configured by a method of adding new UE capability related to the maximum uplink duty cycle.

TABLE 21
In relation to ΔP_{PowerClass}
- In the next case, a UE that supports power class 2 may be configured to 3dB,
a UE that supports power class 1.5 may be configured to 6dB, a UE that
supports power class 1.7 may be configured to 4.8dB, and a UE that supports
power class 1.2 may be configured to 7dB. In case that the BS has configured
the P-max value to be 23dBm or lower, or in case that the field of UE
capability maxUplinkDutyCycle-PC2-FR1 is empty, maxUplinkDutyCycle-
PC1dot5-MPE-FR1 is empty, maxUplinkDutyCycle-27dot8-FR1 is empty, and
the ratio of uplink symbols transmitted for a predetermined measurement time
is larger than 50%, or in case that, as defined in TS 38.306 (the exact
measurement time is longer than one radio wave frame), the field of UE
capability maxUplinkDutyCycle-PC2-FR1 is not empty, and the ratio of uplink
symbols transmitted for a predetermined measurement time is larger than
maxUplinkDutyCycle-PC2-FR1, or in case that, as defined in TS 38.306 (the
exact measurement time is longer than one radio wave frame), the field of UE
capability maxUplinkDutyCycle-PC1dot5-MPE-FR1 is not empty, and half the
ratio of uplink symbols transmitted for a predetermined measurement time is
larger than maxUplinkDutyCycle-PC1dot5-MPE-FR1, or in case that, as
defined in TS 38.306 (the exact measurement time is longer than one radio
wave frame), the field of UE capability maxUplinkDutyCycle-27dot8-FR1 is
not empty, and 60% of the ratio of uplink symbols transmitted for a
predetermined measurement time is larger than maxUplinkDutyCycle-27dot8-
FR1, or in case that, as defined in TS 38.306 (the exact measurement time is
longer than one radio wave frame), the field of UE capability
maxUplinkDutyCycle-30-FR1 is not empty, and 40% of the ratio of uplink
symbols transmitted for a predetermined measurement time is larger than
maxUplinkDutyCycle-30-FR1.
- In the next case, a UE that supports power class 1.5 may be configured to
3dB, a UE that supports power class 1.7 may be configured to 1.8dB, and a UE
that supports power class 1.2 may be configured to 4dB. In case that the BS
has configured the P-max to be between 23dBm and 26dBm, or in case that the
field of UE capability maxUplinkDutyCycle-PC2-FR1 is empty,
maxUplinkDutyCycle-PC1dot5-MPE-FR1 is empty, maxUplinkDutyCycle-
27dot8-FR1 is empty, maxUplinkDutyCycle-30-FR1 is empty, and the ratio of
uplink symbols transmitted for a predetermined measurement time is between
30% and 50%, or in case that, as defined in TS 38.306 (the exact measurement
time is longer than one radio wave frame), the field of UE capability
maxUplinkDutyCycle-PC2-FR1 is not empty, and the ratio of uplink symbols
transmitted for a predetermined measurement time is between
maxUplinkDutyCycle-PC2-FR1 and maxUplinkDutyCycle-PC2-FR1 * 0.6, or
in case that, as defined in TS 38.306 (the exact measurement time is longer
than one radio wave frame), the field of UE capability maxUplinkDutyCycle-
PC1dot5-MPE-FR1 is not empty, and the ratio of uplink symbols transmitted
for a predetermined measurement time is larger than maxUplinkDutyCycle-
PC1dot5-MPE-FR1, or in case that, as defined in TS 38.306 (the exact
measurement time is longer than one radio wave frame), the field of UE
capability maxUplinkDutyCycle-27dot8-FR1 is not empty, and the ratio of
uplink symbols transmitted for a predetermined measurement time is larger
than maxUplinkDutyCycle-27dot8-FR1, or in case that, as defined in TS
38.306 (the exact measurement time is longer than one radio wave frame), the
field of UE capability maxUplinkDutyCycle-30-FR1 is not empty, and the ratio
of uplink symbols transmitted for a predetermined measurement time is
between maxUplinkDutyCycle-30-FR1 * (2.5) and maxUplinkDutyCycle-30-
FR1 * (1.5). In the next case, a UE that supports power class 1.5 may be
configured to 1.2dB, and a UE that supports power class 1.2 may be configured
to 2.2dB. In case that the BS has configured the P-max value to be between
26dBm and 27.8dBm, or in case that the field of UE capability
maxUplinkDutyCycle-PC2-FR1 is empty, maxUplinkDutyCycle-PC1dot5-
MPE-FR1 is empty, maxUplinkDutyCycle-30-FR1 is empty, and the ratio of
uplink symbols transmitted for a predetermined measurement time is between
25% and 30%, or in case that, as defined in TS 38.306 (the exact measurement
time is longer than one radio wave frame), the field of UE capability
maxUplinkDutyCycle-PC2-FR1 is not empty, and the ratio of uplink symbols
transmitted for a predetermined measurement time is between
maxUplinkDutyCycle-PC2-FR1 * 0.6 and maxUplinkDutyCycle-PC2-FR1 / 2,
or in case that, as defined in TS 38.306 (the exact measurement time is longer
than one radio wave frame), the field of UE capability maxUplinkDutyCycle-
PC1dot5-MPE-FR1 is not empty, and the ratio of uplink symbols transmitted
for a predetermined measurement time is larger than maxUplinkDutyCycle-
PC1dot5-MPE-FR1 * (1.2), or in case that, as defined in TS 38.306 (the exact
measurement time is longer than one radio wave frame), the field of UE
capability maxUplinkDutyCycle-30-FR1 is not empty, and the ratio of uplink
symbols transmitted for a predetermined measurement time is
maxUplinkDutyCycle-30-FR1 * (1.5) and maxUplinkDutyCycle-30-FR1 *
(1.25).
In the next case, a UE that supports power class 1.2 may be configured to 1dB.
In case that the BS has configured the P-max value to be between 27.8dBm
and 29dBm, or in case that UE capability maxUplinkDutyCycle-30-FR1 is
empty, and the ratio of uplink symbols transmitted for a predetermined
measurement time is between 20% and 25%, or in case that, as defined in TS
38.306 (the exact measurement time is longer than one radio wave frame), the
field of UE capability maxUplinkDutyCycle-30-FR1 is not empty, and the ratio
of uplink symbols transmitted for a predetermined measurement time is larger
than maxUplinkDutyCycle-30-FR1.

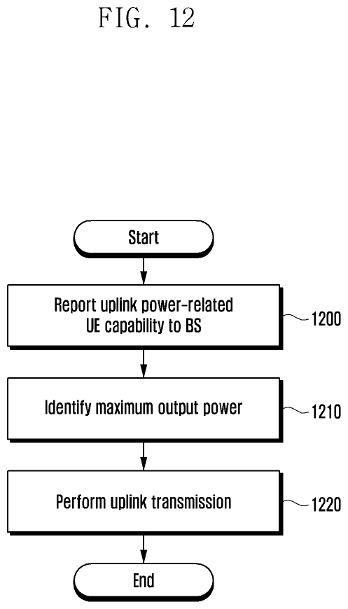

FIG. 12 illustrates operations of a UE configured to perform operations according to an embodiment of the disclosure.

Referring to FIG. 12, the UE reports uplink power-related UE capability to the BS in operation 1200. The uplink power-related UE capability may include at least one of the above-described UE capability parameters such as the number and/or power class (or supported maximum power) of PAs of the UE, the number and/or power class of additional PAs, information regarding sum power different from legacy power classes, whether a new power class is supported or not, the UE's maximum duty cycle information.

After reporting the UE capability, the UE may acquire at least one of ΔP_{PowerClass} value, P_{Powerclass} or P_{PowerClass}+[P_{3Tx}] value in the above-described method. Thereafter, the UE may calculate P_{CMAX} according to the above-described method, based on the acquired value in operation 1210, and may transmit an uplink signal during uplink scheduling by the BS according to the P_{CMAX} in operation 1220.

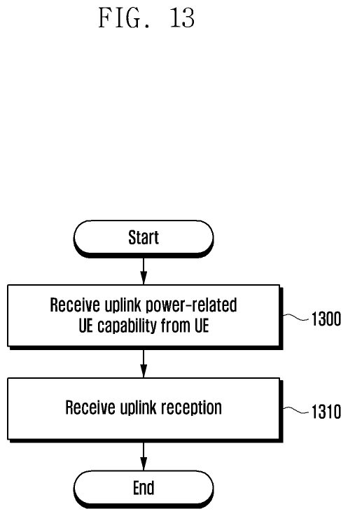

FIG. 13 illustrates operations of a BS configured to perform operations according to an embodiment of the disclosure.

Referring to FIG. 13, the BS receives uplink power-related UE capability from the UE in operation 1300. The uplink power-related UE capability may include at least one of the above-described UE capability parameters, such as the number and/or power class (or supported maximum power) of PAs of the UE, the number and/or power class of additional PAs, information regarding sum power different from legacy power classes, whether a new power class is supported or not, the UE's maximum duty cycle information. The BS may indicate a new output to the UE according to the channel state during uplink scheduling based on such UE capability report and information.

The BS receives an uplink signal from the UE in operation 1310. The BS may recognize that the UE has acquired at least one of ΔP_{PowerClass} value, P_{Powerclass} Or P_{PowerClass}+[P_{3Tx}] value in the above-described method, and has calculated P_{CMAX} according to the above-described method, based on the acquired value.

FIG. 14 illustrates a structure of a UE in a wireless communication system according to an embodiment of the disclosure.

Referring to FIG. 14, the UE may include a transceiver, which refers to a UE receiver 1400 and a UE transmitter 1410 as a whole, memory (not illustrated), and a UE processor 1405 (or UE controller or processor). The UE receiver 1400 and the UE transmitter 1410, the memory, and the UE processor 1405 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media, such as read only memory (ROM), random access memory (RAM), hard disk, compact disc read only memory (CD-ROM), and digital versatile disc (DVD), or a combination of storage media. In addition, the memory may include multiple memories.

Furthermore, the processor may control a series of processes such that the UE can operate according to the above-described embodiments. The processor may include multiple processors, and the processor may perform operations of controlling the components of the UE by executing programs stored in the memory.

FIG. 15 illustrates a structure of a base station in a wireless communication system according to an embodiment of the disclosure.

Referring to FIG. 15, the base station may include a transceiver, which refers to a base station receiver 1500 and a base station transmitter 1510 as a whole, memory (not illustrated), and a base station processor 1505 (or base station controller or processor). The base station receiver 1500 and the base station transmitter 1510, the memory, and the base station processor 1505 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media, such as ROM, RAM, hard disk, CD-ROM, and DVD, or a combination of storage media. In addition, the memory may include multiple memories.

The processor may control a series of processes such that the base station can operate according to the above-described embodiments of the disclosure. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural.

The embodiments of the disclosure described and shown in the specification and the drawings are merely specific examples that have been presented to easily explain the technical contents of the disclosure and help understanding of the disclosure, and are not intended to limit the scope of the disclosure. For example, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the frequency division duplex (FDD) LTE system, other variants based on the technical idea of the embodiments may also be implemented in other communication systems, such as time division duplex (TDD) LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
transmitting, to a base station, by the UE, UE capability information associated with an output power of a 3^{rd} power amplifier (PA);
identifying, by the UE, a maximum UE transmit power P_{CMAX} based on the output power of the 3^{rd} PA and output powers of a 1^{st} PA and a 2^{nd} PA; and
transmitting, to the base station, by the UE, an uplink signal based on the identified P_{CMAX}.

2. The method of claim 1, wherein the UE capability information indicates the output power of the 3^{rd} PA as one of 23 dBm or 26 dBm.

3. The method of claim 1,
wherein the P_{CMAX} is identified based on a lower limit value P_{CMAX,L} and a higher limit value P_{CMAX,H}, and
wherein the P_{CMAX,L} and the P_{CMAX,H} are identified based on the UE capability information.

4. The method of claim 1, wherein in case that the UE capability information indicates 0 dBm, the P_{CMAX} is identified based on the output powers of the 1^{st} PA and the 2^{nd} PA2.

5. The method of claim 1, wherein in case that UE capability information associated a maximum uplink duty cycle is reported, a parameter ΔP_{Powerclass} for the P_{CMAX} is identified based on the UE capability information associated the maximum uplink duty cycle and a ratio of uplink resource.

6. A method performed by a base station in a communication system, the method comprising:
receiving, from a user equipment (UE), by the base station, UE capability information associated with an output power of a 3^{rd} power amplifier (PA); and
receiving, from the UE, by the base station, an uplink signal,
wherein the UL signal is transmitted based on a maximum UE transmit power P_{CMAX}, and
wherein the P_{CMAX} is based on the output power of the 3^{rd} PA and output powers of a 1^{st} PA and a 2^{nd} PA.

7. The method of claim 6, wherein the UE capability information indicates the output power of the 3^{rd} PA as one of 23 dBm or 26 dBm.

8. The method of claim 6,
wherein the P_{CMAX} is based on a lower limit value P_{CMAX,L} and a higher limit value P_{CMAX,H}, and
wherein the P_{CMAX,L} and the P_{CMAX,H} are associated with the UE capability information.

9. The method of claim 6, wherein in case that the UE capability information indicates 0 dBm, the P_{CMAX} is based on the output powers of the 1^{st} PA and the 2^{nd} PA2.

10. The method of claim 6, wherein in case that UE capability information associated a maximum uplink duty cycle is received, a parameter ΔP_{Powerclass} for the P_{CMAX} is based on the UE capability information associated the maximum uplink duty cycle and a ratio of uplink resource.

11. A user equipment (UE) in a communication system, the UE comprising:
a transceiver; and
a controller configured to:
transmit, to a base station, UE capability information associated with an output power of a 3^{rd} power amplifier (PA),
identify a maximum UE transmit power P_{CMAX} based on the output power of the 3^{rd} PA and output powers of a 1^{st} PA and a 2^{nd} PA, and
transmit, to the base station, an uplink signal based on the identified P_{CMAX}.

12. The UE of claim 11, wherein the UE capability information indicates the output power of the 3^{rd} PA as one of 23 dBm or 26 dBm.

13. The UE of claim 11,
wherein the P_{CMAX} is identified based on a lower limit value P_{CMAX,L} and a higher limit value P_{CMAX,H}, and
wherein the P_{CMAX,L} and the P_{CMAX,H} are identified based on the UE capability information.

14. The UE of claim 11, wherein in case that the UE capability information indicates 0 dBm, the P_{CMAX} is identified based on the output powers of the 1^{st} PA and the 2^{nd} PA2.

15. The UE of claim 11, wherein in case that UE capability information associated a maximum uplink duty cycle is reported, a parameter ΔP_{Powerclass} for the P_{CMAX} is identified based on the UE capability information associated the maximum uplink duty cycle and a ratio of uplink resource.

16. A base station in a communication system, the base station comprising:
a transceiver; and
a controller configured to:
receive, from a user equipment (UE), UE capability information associated with an output power of a 3^{rd} power amplifier (PA), and
receive, from the UE, an uplink signal,
wherein the UL signal is transmitted based on a maximum UE transmit power P_{CMAX}, and
wherein the P_{CMAX} is based on the output power of the 3^{rd} PA and output powers of a 1^{st} PA and a 2^{nd} PA.

17. The base station of claim 16, wherein the UE capability information indicates the output power of the 3^{rd} PA as one of 23 dBm or 26 dBm.

18. The base station of claim 16,
wherein the P_{CMAX} is based on a lower limit value P_{CMAX,L} and a higher limit value P_{CMAX,H}, and
wherein the P_{CMAX,L} and the P_{CMAX,H} are associated with the UE capability information.

19. The base station of claim 16, wherein in case that the UE capability information indicates 0 dBm, the P_{CMAX} is based on the output powers of the 1^{st} PA and the 2^{nd} PA2.

20. The base station of claim 16, wherein in case that UE capability information associated a maximum uplink duty cycle is received, a parameter ΔP_{Powerclass} for the P_{CMAX} is based on the UE capability information associated the maximum uplink duty cycle and a ratio of uplink resource.
